(19) United States
(12) Patent Application Publication
(10) Pub. No.: US 2026/0197625 A1
(43) Pub. Date: Jul. 9, 2026

(54) METHODS AND APPARATUSES FOR CONVEYING TRAFFIC OFFLOAD POLICIES TO VPLMN FOR HOME ROUTED SESSIONS BREAKOUT

(71) Applicant: TELEFONAKTIEBOLAGET LM ERICSSON (PUBL), Stockholm (SE)

(72) Inventors: Attila Mihály, Budapest (HU); Magnus Hallenstål, Stockholm (SE); Magnus Olsson

(21) Appl. No.: 19/132,596

(22) PCT Filed: Dec. 21, 2023
(86) PCT No.: PCT/IB2023/063141

§ 371 Date: May 23, 2025

Related U.S. Application Data
(60) Provisional application No. 63/434,536, filed on Dec. 22, 2022.

(51) Int. Cl. H04W 8/12; H04W 28/10

(52) U.S. Cl. CPC H04W 8/12; H04W 28/10

(57) ABSTRACT

Methods and apparatus are provided for transferring policy information between a first network and a home network of a User Equipment (UE) accessing Edge Hosting Environment (EHE) in the first network. One method implemented in a first session management function (SMF) in the first network (VPLMN) comprises sending to a second SMF in the home network a request for a Packet Data Unit (PDU) session establishment for the UE indicating that the first SMF requests authorization for home routed session breakout (HR-SBO) for the PDU session and receiving from the second SMF a response message including one or more offload identifiers (IDs), each ID of the one or more offload IDs identifies one or more offload policies for Edge Computing (EC) services, to be applied at the first network. Transferring the offload policies themselves is not always required, only IDs are used.

### RELATED APPLICATIONS

This application claims the benefit of provisional patent application Ser. No. 63/434,536, filed on Dec. 22, 2022, the disclosure of which is hereby incorporated herein by reference in its entirety.

### TECHNICAL FIELD

The present disclosure relates to a wireless communication system and, more specifically, a wireless communication system supporting policies in roaming for home routing and local breakout.

### BACKGROUND

In a 5G wireless network of FIG. 2, there can be various network functions, including, but not limited to:
SMF (Session Management Function), that is responsible for Session establishment, modification and release, including selection and control of the UPF entities, maintaining the topology of the involved PSA UPFs, establishing and releasing the tunnel between AN and UPF and between UPFs. It also configures traffic forwarding at UPF. The SMF interacts with the UPF over N4 Reference point using PFCP procedures.
UPF (User Plane Function), that handles the user data traffic. Among other, it provides the external PDU Session point of interconnect to Data Network (PDU session anchor, PSA) and performs packet routing & forwarding (e.g. support of Uplink classifier (UL CL) to route traffic flows to an instance of a data network, support of Branching point to support multi-homed PDU Session).
PCF (Policy Control Function), supports a unified policy framework to govern the network behavior. Specifically, for this invention, the PCF provides PCC (Policy and Charging Control) rules to the PCEF (Policy and Charging Enforcement Function), i.e. the SMF/UPF that enforces policy and charging decisions according to provisioned PCC rules.
NEF (Network Exposure Function), supports different functionality and specifically in the context of this IvD, NEF acts as the entry point into operator's network, so an external AF (Content Provider) interacts with the 3GPP Core Network through NEF.
AF (Application Function), may send requests to influence SMF routing decisions for traffic of PDU Session. The AF requests may influence UPF (re) selection and allow routing user traffic to a local access to a Data Network (identified by a DNAI). The AF may communicate directly with PCF in the SBA domain or indirectly through the NEF, i.e., having an API to the NEF that conveys the AF communication to the PCF.
UDM (Unified Data Management): is a front-end for the user subscription data stored in the UDR. The UDM uses subscription data that may be stored in UDR to execute application logic like access authorization, registration management and reachability for terminating event e.g., SMS.

As stated in TS 23.501 v.17.4.0, clause 5.13, Edge computing enables operator and 3rd party services to be hosted close to the UE's access point of attachment, in order to achieve an efficient service delivery through the reduced end-to-end latency and load on the transport network. The 5G Core Network selects a UPF close to the UE and executes the traffic steering from the UPF to the local Data Network via a N6 interface.

A number of enablers have been defined that alone or in combination support Edge Computing (clause 5.13. in TS 23.501 v.17.4.0). Among the enablers are included:
User plane (re) selection: the 5G Core Network (re) selects UPF to route the user traffic to the local Data Network as described in clause 6.3.3 in TS 23.501 v.17.4.0;
Local Routing and Traffic Steering: the 5G Core Network selects the traffic to be routed to the applications in the local Data Network;
   this includes the use of a single PDU Session with multiple PDU Session Anchor(s) (UL CL/IP v6 multi-homing) as described in clause 5.6.4 in TS 23.501 v.17.4.0.
Session and service continuity to enable UE and application mobility as described in clause 5.6.9 in TS 23.501 v.17.4.0,
An Application Function (AF) may influence UPF (re) selection and traffic routing via PCF or NEF

Edge Computing (EC) enables operator and 3rd party services to be hosted close to the UE's access point of attachment, in order to achieve an efficient service delivery through the reduced end-to-end latency and load on the transport network.

FIG. 3A depicts 5GS architecture for non-roaming scenario supporting Edge Computing with UL CL/BP and FIG. 3B depicts 5GS architecture for non-roaming scenario supporting Edge Computing without UL CL/BP.

To support the Edge Application Server (EAS) discovery procedure, an Edge Application Server Discovery Function (EASDF) is introduced in TS 23.548 that implements (among others) the handling the DNS messages according to the instruction from the SMF, including:
Receiving DNS message handling rules from SMF
Exchanging DNS messages from the UE
Forwarding DNS messages to Central DNS (C-DNS) or local DNS (L-DNS) for DNS query
Adding Extended DNS (EDNS) Client Subnet (ECS) option (as defined in RFC 7871) into DNS query for an FQDN
Notifying EASDF related information to SMF
Terminates the DNS security if DNS over TLS (DOT), DNS over HTTPS (DoH) or DNS over DTLS is used.

The EASDF has user plane connectivity with the PSA UPF over N6 for the transmission of DNS signaling exchanged with the UE. If the UE applications want to discover/access EAS by using the mechanisms defined in TS 23.548, the DNS queries generated by the UE shall be sent to the EASDF as DNS resolver indicated by the SMF.

There currently exist certain challenge(s). More specifically, neither the functionality for Edge Computing (EC) for Release 16 defined in 3GPP TS 23.501, nor the Release 17 enhancements defined in 3GPP TS 23.548 v17.4.0 provide functionality for accessing Edge Hosting Environment (EHE) in a VPLMN when roaming. Therefore, this has been defined as a key issue to resolve in the Release 18 study (Key Issue #1 in 3GPP TS 23.700-48 v2.0.0). There are two alternative scenarios to consider, i.e. UE accessing Edge Hosting Environment (EHE) in VPLMN via an Local Breakout (LBO) PDU Session and UE accessing EHE in VPLMN via a PDU Session established as Home Routing (HR).

The UE roaming scenario accessing EHE in a HR PDU session, called Home Routed Session BreakOut (HR-SBO) scenario, is depicted in FIG. 4 that illustrates a 5G network architecture for a home routing session breakout in a visited PLMN. This architecture includes a home PLMN and the visited PLMN. NFs in the home PLMN are sometimes noted herein using the “H-” prefix, whereas NFs in the visited PLMN are sometimes noted herein using the “V-” prefix. In this architecture, the visited PLMN includes NEF 300, NRF 302, V-PCF 324, AMF 322 (denoted here as AMF in the visited network, similar to AMF 200 in FIG. 2), V-SMF 328, V-EASDF 316, UPF Uplink Classifier Branch Point (UL CL/BP) 330-1, a UPF Local Protocol Data Unit Session Anchor (PSA) 330-2, and AF 326. The UPF Local PSA 330-2 is connected to a DN which, in this example, includes an EAS 314. The home PLMN includes H-EASDF 318, H-PCF 312, UDM 308, H-SMF 310, H-DNS, 320, and H-UPF 306, which is connected to a central DN 316.

At the time of submitting this application, normative work has started for Release 18 of 3GPP, and the 3GPP change request S2-2211366 for TS 23.548 related to roaming HR-SBO scenario (Key Issue #1 in 3GPP TS 23.700-48 v2.0.0) has been approved to be incorporated into TS 23.548 during SA2 meeting #154. It proposes the procedure for HR-SBO scenario as illustrated in FIG. 5.

### The Following Further Describes the Steps of FIG. 5 as Currently Approved to the Standard TS 23.548:

Step 1: During the registration procedure, the AMF receives the HR-SBO allowed indication per DNN/S-NSSAI from the UDM in the step 14b of the procedure in the clause 4.2.2.2.2 of TS 23.502 V. 17.4.0.
Step 2: During the PDU Session establishment procedure for Home-routed roaming as in clause 4.3.2.2.2 of TS 23.502 V. 17.4.0, if the AMF 322 receives the HR-SBO allowed indication for requested DNN/S-NSSAI in the step 1, the AMF 322 selects V-SMF 328 supporting HR-SBO.
   Editor's Note: It is For Further Study (FFS) whether the AMF 322 sends an indication that the requested session is allowed for HR-SBO PDU Session to the V-SMF 328. If agreed, this indication can be used for the V-SMF 328 to decide whether to request HR-SBO PDU Session to the H-SMF 310.
   Editor's Note: It is For Further Study (FFS) when the V-SMF 328 selects V-EASDF 316. In other words, V-SMF 328 selects the V-EASDF 316 either 1) before sending Nsmf_PDUSession_Create Request for HR-SBO PDU Session to H-SMF 310 or 2) after receiving Nsmf_PDUSession_Create response from H-SMF 310.

The V-SMF 328 sends the request for the establishment of the PDU Session supporting HR-SBO in VPLMN and the V-EASDF 316 address to H-SMF 310. The H-SMF 310 authorizes the request based on SM subscription data and provides optional VPLMN specific offloading policy (if available in HPLMN based on the SLA between HPLMN and VPLMN) and the DNS server address of HPLMN to V-SMF 328.

Editor's Note: It is FFS that the SM subscription data includes 1) HR-SBO authorization indication or 2) HR-SBO authorization information including VPLMN specific offloading policy. If only HR-SBO authorization indication is added, the H-SMF 310 retrieves the VPLMN specific offloading policy from H-PCF 312 if available at H-PCF 312 based on the SLA between HPLMN and VPLMN.
Editor's Note: The detailed information (e.g. FQDN range, IP range, AMBR for the local part of DN or charging policy) of VPLMN specific offloading policy is FFS.
NOTE 2: The VPLMN specific offloading policy can be prior configured in HPLMN based on the service level agreement between the VPLMN and HPLMN.

The H-SMF 310 also constructs Protocol Configuration Option (PCO) with DNS server address field set to V-EASDF address and sends the PCO to the V-SMF 328.

Step 3: The V-SMF 328 configures the V-EASDF 316 with the DNS handling rules using the optional VPLMN specific offloading policy and the DNS server address of HPLMN if they are received from H-SMF 310 in the step 2.

Editor's Note: It is for further study (FFS) how EAS (re)-discovery procedure for HR-SBO roaming scenario is performed.

As will be described below, the embodiments address the editor's notes that describe the issues for further study.
In order to understand the solution presented herein, it is key to understand how the current state of the art address subscription data in the UDM 308.

TS 23.502 V.17.4.0 lists the UE subscription data attributes as reproduced in Table 1 below:

TABLE 1
UE Subscription data types (see Table 5.2.3.3.1-1 in TS 23.502 V.17.4.0)

| Subscription data | | |
|---|---|---|
| type | Field | Description |
| Access and Mobility | GPSI List | List of the GPSI (Generic Public Subscription |
| Subscription data | | Identifier) used both inside and outside of the |
| (data needed for UE | | 3GPP system to address a 3GPP subscription |
| Registration and | | (see NOTE 9). |
| Mobility | Internal Group ID-list | List of the subscribed internal group(s) that the |
| Management) | | UE belongs to. |
| | Subscribed UE-AMBR | The maximum aggregated uplink and downlink |
| | | MBRs to be shared across all Non-GBR QoS |
| | | Flows according to the subscription of the user. |
| | Subscribed UE-Slice-MBR(s) | List of maximum aggregated uplink and downlink |
| | | MBRs to be shared across all GBR and Non-GBR |
| | | QoS Flows related to the same S-NSSAI |
| | | according to the subscription of the user. There is |
| | | a single uplink and a single downlink value per S- |
| | | NSSAI. |
| | Subscribed S-NSSAIs | The Network Slices that the UE subscribes to. In |
| | | the roaming case, it indicates the subscribed |
| | | Network Slices applicable to the Serving PLMN |
| | | (NOTE 11). |
| | Default S-NSSAIs | The Subscribed S-NSSAIs marked as default S- |
| | | NSSAI. In the roaming case, only those applicable |
| | | to the Serving PLMN (NOTE 12). |
| | S-NSSAIs subject to Network | The Subscribed S-NSSAIs marked as subject to |
| | Slice-Specific Authentication | NSSAA. When present, the GPSI list shall include |
| | and Authorization | at least one GPSI. |
| | Network Slice Simultaneous | Optionally, for each S-NSSAI in the Subscribed S- |
| | Registration Group Information | NSSAIs, one or more value of Network Slice |
| | | Simultaneous Registration Group(s) (NOTE 11) |
| | | associated with the S-NSSAI. |
| | UE Usage Type | As defined in clause 5.15.7.2 of TS 23.501 [2]. |
| | RAT restriction | 3GPP Radio Access Technology(ies) not allowed |
| | | the UE to access. |
| | Forbidden area | Defines areas in which the UE is not permitted to |
| | | initiate any communication with the network. |
| | Service Area Restriction | Indicates Allowed Areas in which the UE is |
| | | permitted to initiate communication with the |
| | | network, and Non-allowed areas in which the UE |
| | | and the network are not allowed to initiate Service |
| | | Request or SM signalling to obtain user services. |
| | Core Network type restriction | Defines whether UE is allowed to connect to 5GC |
| | | and/or EPC for this PLMN. |
| | CAG information | The CAG information includes Allowed CAG list |
| | | and, optionally an indication whether the UE is |
| | | only allowed to access 5GS via CAG cells as |
| | | defined in clause 5.30.3 of TS 23.501 [2]. |
| | CAG information Subscription | When present, indicates to the serving AMF that |
| | Change Indication | the CAG information in the subscription data |
| | | changed and the UE must be updated. |
| | RFSP Index | An index to specific RRM configuration in the NG- |
| | | RAN. |
| | Subscribed Periodic | Indicates a subscribed Periodic Registration |
| | Registration Timer | Timer value, which may be influenced by e.g. |
| | | network configuration parameter as specified in |
| | | clause 4.15.6.3a. |
| | Subscribed Active Time | Indicates a subscribed active time value, which |
| | | may be influenced by e.g. network configuration |
| | | parameter as specified in clause 4.15.6.3a. |
| | MPS priority | Indicates the user is subscribed to MPS as |
| | | indicated in clause 5.16.5 of TS 23.501 [2]. |
| | MCX priority | Indicates the user is subscribed to MCX as |
| | | indicated in clause 5.16.6 of TS 23.501 [2]. |
| | AMF-Associated Expected UE | Information on expected UE movement and |
| | Behaviour parameters | communication characteristics. See |
| | | clause 4.15.6.3 |
| | Steering of Roaming | List of preferred PLMN/access technology |
| | | combinations and/or Credentials Holder controlled |
| | | prioritized lists of preferred SNPNs and GINs or |
| | | HPLMN/Credentials Holder indication that no |
| | | change of the above list(s) stored in the UE is |
| | | needed (see NOTE 3). |
| | | Optionally includes an indication that the UDM |
| | | requests an acknowledgement of the reception of |
| | | this information from the UE. |
| | SoR Update Indicator for Initial | An indication whether the UDM requests the AMF |
| | Registration | to retrieve SoR information when the UE performs |
| | | Registration with NAS Registration Type “Initial |
| | | Registration”. |
| | SoR Update Indicator for | An indication whether the UDM requests the AMF |
| | Emergency Registration | to retrieve SoR information when the UE performs |
| | | Registration with NAS Registration Type |
| | | “Emergency Registration”. |
| | Network Slicing Subscription | When present, indicates to the serving AMF that |
| | Change Indicator | the subscription data for network slicing changed |
| | | and the UE configuration must be updated. |
| | Provide the UE with the full set | Indicates the AMF to provide the UE with the full |
| | of subscribed S-NSSAIs | set of subscribed S-NSSAIs even if they do not |
| | | share a common NSSRG. |
| | Tracing Requirements | Trace requirements about a UE (e.g. trace |
| | | reference, address of the Trace Collection Entity, |
| | | etc.) is defined in TS 32.421 [39]. |
| | | This information is only sent to AMF in the |
| | | HPLMN or one of its equivalent PLMN(s). |
| | Inclusion of NSSAI in RRC | When present, it is used to indicate that the UE is |
| | Connection Establishment | allowed to include NSSAI in the RRC connection |
| | Allowed | Establishment in clear text for 3GPP access. |
| | Service Gap Time | Used to set the Service Gap timer for Service Gap |
| | | Control (see clause 5.31.16 of TS 23.501 [2]). |
| | Subscribed DNN list | List of the subscribed DNNs for the UE (NOTE 1). |
| | | Used to determine the list of LADN available to |
| | | the UE as defined in clause 5.6.5 of |
| | | TS 23.501 [2]. |
| | UDM Update Data | Includes a set of parameters see clause 4.20.1 for |
| | | parameters possible to deliver) to be delivered |
| | | from UDM to the UE via NAS signalling as defined |
| | | in clause 4.20 (NOTE 3). |
| | | Optionally includes an indication that the UDM |
| | | requests an acknowledgement of the reception of |
| | | this information from the UE and an indication for |
| | | the UE to re-register. |
| | NB-IoT UE priority | Numerical value used by the NG-RAN to prioritise |
| | | between UEs accessing via NB-IoT. |
| | Enhanced Coverage Restriction | Specifies whether CE mode B is restricted for the |
| | | UE, or both CE mode A and CE mode B are |
| | | restricted for the UE, or both CE mode A and CE |
| | | mode B are not restricted for the UE. |
| | NB-IoT Enhanced Coverage | Indicates whether Enhanced Coverage for NB-IoT |
| | Restriction | UEs is restricted or not. |
| | IAB-Operation allowed | Indicates that the subscriber is allowed for IAB- |
| | | operation as specified in clause 5.35.2 of |
| | | TS 23.501 [2]. |
| | Charging Characteristics | It contains the Charging Characteristics as |
| | | defined in Annex A of TS 32.256 [71]. |
| | | This information, when provided, shall override |
| | | any corresponding predefined information at the |
| | | AMF. |
| | Extended idle mode DRX cycle | Indicates a subscribed extended idle mode DRX |
| | length | cycle length value. |
| | PCF Selection Assistance info | list of combination of DNN and S-NSSAI that |
| | | indicates that the same PCF needs to be selected |
| | | for AM Policy Control and SM Policy Control |
| | | (NOTE 10). |
| | AerialUESubscriptionInfo | Aerial UE Subscription Information. It contains an |
| | | Indication on whether Aerial service for the UE is |
| | | allowed or not. |
| | Routing Indicator | Routing Indicator assigned to the SUPI. |
| Slice Selection | Subscribed S-NSSAIs | The Network Slices that the UE subscribes to. In |
| Subscription data | | roaming case, it indicates the subscribed network |
| (data needed for | | slices applicable to the serving PLMN (NOTE 11). |
| Slice Selection as | Default S-NSSAIs | The Subscribed S-NSSAIs marked as default S- |
| described in | | NSSAI. In the roaming case, only those applicable |
| clause 4.2.2.2.3 and | | to the Serving PLMN (NOTE 12). |
| in clause 4.11.0a.5) | S-NSSAIs subject to Network | The Subscribed S-NSSAIs marked as subject to |
| | Slice-Specific Authentication | NSSAA. |
| | and Authorization | |
| | Network Slice Simultaneous | Optionally, for each S-NSSAI in the Subscribed S- |
| | Registration Group (NSSRG) | NSSAIs, the one or more value of Network Slice |
| | Information | Simultaneous Registration Group(s) (NOTE 11) |
| | | associated with the S-NSSAI. |
| SMF Selection | SUPI | Key |
| Subscription data | SMF Selection Subscription data contains one or more S-NSSAI level | |
| (data needed for SMF | subscription data: | |
| Selection as | S-NSSAI | Indicates the value of the S-NSSAI. |
| described | Subscribed DNN list | List of the subscribed DNNs for the UE (NOTE 1). |
| in clause 6.3.2 of | Default DNN | The default DNN if the UE does not provide a |
| TS 23.501 [2]) | | DNN (NOTE 2). |
| | DNN(s) subject to aerial | List of DNNs that are used for aerial services (e.g. |
| | services | UAS operations or C2, etc.) as described in |
| | | TS 23.256 [80]. (see NOTE 13). |
| | LBO Roaming Information | Indicates whether LBO roaming is allowed per |
| | | DNN, or per (S-NSSAI, subscribed DNN). |
| | | (NOTE 16) |
| | Interworking with EPS indication | Indicates whether EPS interworking is supported |
| | list | per (S-NSSAI, subscribed DNN). |
| | Same SMF for Multiple PDU | Indication whether the same SMF for multiple |
| | Sessions to the same DNN and | PDU Sessions to the same DNN and S-NSSAI is |
| | S-NSSAI | required. |
| | Invoke NEF indication | When present, indicates, per S-NSSAI and per |
| | | DNN, that NEF based infrequent small data |
| | | transfer shall be used for the PDU Session (see |
| | | NOTE 8). |
| | SMF information for static IP | When static IP address/prefix is used, this may be |
| | address/prefix | used to indicate the associated SMF information |
| | | per (S-NSSAI, DNN). |
| UE context in SMF | SUPI | Key. |
| data | PDU Session Id(s) | List of PDU Session Id(s) for the UE. |
| | For emergency PDU Session Id: | |
| | Emergency Information | The SMF + PGW-C FQDN for emergency session |
| | | used for interworking with EPC. |
| | For each non-emergency PDU Session Id: | |
| | DNN | DNN for the PDU Session. |
| | SMF | Allocated SMF for the PDU Session. Includes |
| | | SMF IP Address and SMF NF Id. |
| | SMF + PGW-C FQDN | The S5/S8 SMF + PGW-C FQDN used for |
| | | interworking with EPS (see NOTE 5). |
| | PCF ID | The PCF ID serving the PDU Session/PDN |
| | | Connection. |
| SMS Management | SMS parameters | Indicates SMS parameters subscribed for SMS |
| Subscription data | | service such as SMS teleservice, SMS barring list |
| (data needed by | Trace Requirements | Trace requirements about a UE (e.g. trace |
| SMSF for SMSF | | reference, address of the Trace Collection Entity, |
| Registration) | | etc.) is defined in TS 32.421 [39]. |
| | | This information is only sent to a SMSF in |
| | | HPLMN. |
| | Routing Indicator | Routing Indicator assigned to the SUPI. |
| SMS Subscription | SMS Subscription | Indicates subscription to any SMS delivery service |
| data | | over NAS irrespective of access type. |
| (data needed in AMF) | | |
| UE Context in SMSF | SMSF Information | Indicates SMSF allocated for the UE, including |
| data | | SMSF address and SMSF NF ID. |
| | Access Type | 3GPP or non-3GPP access through this SMSF |
| Session Management | GPSI List | List of the GPSI (Generic Public Subscription |
| Subscription data | | Identifier) used both inside and outside of the |
| (data needed for PDU | | 3GPP system to address a 3GPP subscription. |
| Session | Internal Group ID-list | List of the subscribed internal group(s) that the |
| Establishment) | | UE belongs to. |
| | Trace Requirements | Trace requirements about a UE (e.g. trace |
| | | reference, address of the Trace Collection Entity, |
| | | etc . . . ) is defined in TS 32.421 [39]. |
| | | This information is only sent to a SMF in the |
| | | HPLMN or one of its equivalent PLMN(s). |
| | Routing Indicator | Routing Indicator assigned to the SUPI. |
| | Session Management Subscription data contains one or more S-NSSAI level | |
| | subscription data: | |
| | S-NSSAI | Indicates the value of the S-NSSAI. |
| | Subscribed DNN list | List of the subscribed DNNs for the S-NSSAI |
| | | (NOTE 1). |
| | For each DNN in S-NSSAI level subscription data: | |
| | DNN | DNN for the PDU Session. |
| | Aerial service indication | Indicates whether the DNN is used for aerial |
| | | services (e.g. UAS operations or C2, etc.) as |
| | | described in TS 23.256 [80]. |
| | Framed Route information | Set of Framed Routes. A Framed Route refers to |
| | | a range of IPv4 addresses/IPv6 Prefixes to |
| | | associate with a PDU Session established on this |
| | | (DNN, S-NSSAI). |
| | | See NOTE 4. |
| | IP Index information | Information used for selecting how the UE IP |
| | | address is to be allocated (see clause 5.8.2.2.1 in |
| | | TS 23.501 [2]). |
| | Allowed PDU Session Types | Indicates the allowed PDU Session Types (IPv4, |
| | | IPv6, IPv4v6, Ethernet, and Unstructured) for the |
| | | DNN, S-NSSAI. See NOTE 6. |
| | Default PDU Session Type | Indicates the default PDU Session Type for the |
| | | DNN, S-NSSAI. |
| | Allowed SSC modes | Indicates the allowed SSC modes for the DNN, S- |
| | | NSSAI. |
| | Default SSC mode | Indicate the default SSC mode for the DNN, S- |
| | | NSSAI. |
| | Interworking with EPS indication | Indicates whether interworking with EPS is |
| | | supported for this DNN and S-NSSAI. |
| | 5GS Subscribed QoS profile | The QoS Flow level QoS parameter values (5QI |
| | | and ARP) for the DNN, S-NSSAI (see |
| | | clause 5.7.2.7 of TS 23.501 [2]). |
| | Charging Characteristics | It contains Charging Characteristics as defined in |
| | | Annex A clause A.1 of TS 32.255 [45]. This |
| | | information, when provided, shall override any |
| | | corresponding predefined information at the SMF. |
| | Subscribed-Session-AMBR | The maximum aggregated uplink and downlink |
| | | MBRs to be shared across all Non-GBR QoS |
| | | Flows in each PDU Session, which are |
| | | established for the DNN, S-NSSAI. |
| | Static IP address/prefix | Indicate the static IP address/prefix for the DNN, |
| | | S-NSSAI. |
| | User Plane Security Policy | Indicates the security policy for integrity protection |
| | | and encryption for the user plane. |
| | PDU Session continuity at inter | Provides for this DDN, S-NSSAI how to handle a |
| | RAT mobility | PDU Session when UE the moves to or from NB- |
| | | IoT. Possible values are: maintain the PDU |
| | | session; disconnect the PDU session with a |
| | | reactivation request; disconnect PDU session |
| | | without reactivation request; or to leave it to local |
| | | VPLMN policy. |
| | NEF Identity for NIDD | When present, indicates, per S-NSSAI and per |
| | | DNN, the identity of the NEF to anchor |
| | | Unstructured PDU Session. When not present for |
| | | the S-NSSAI and DNN, the PDU session |
| | | terminates in UPF (see NOTE 8). |
| | NIDD information | Information such as External Group Identifier, |
| | | External Identifier, MSISDN, or AF Identifier used |
| | | for SMF-NEF Connection. |
| | SMF-Associated Expected UE | Parameters on expected characteristics of a PDU |
| | Behaviour parameters | Session their corresponding validity times as |
| | | specified in clause 4.15.6.3. |
| | Suggested number of downlink | Parameters on expected PDU session |
| | packets | characteristics as specified in clauses 4.15.3.2.3b |
| | | and 4.15.6.3a. |
| | ATSSS information | Indicates whether MA PDU session establishment |
| | | is allowed. |
| | Secondary authentication | Indicates that whether the Secondary |
| | indication | authentication/authorization (as defined in |
| | | clause 5.6 of TS 23.501 [2]) is required for PDU |
| | | Session Establishment as specified in |
| | | clause 4.3.2.3. (see NOTE 14) |
| | DN-AAA Server UE IP address | Indicates that whether the SMF is required to |
| | allocation indication | request the UE IP address from the DN-AAA |
| | | Server (as defined in clause 5.6 of TS 23.501 [2]) |
| | | for PDU Session Establishment as specified in |
| | | clause 4.3.2.3. |
| | DN-AAA Server addressing | If at least one of secondary DN-AAA |
| | information | authentication, DN-AAA authorization or DN-AAA |
| | | UE IP address allocation is required by |
| | | subscription data, the subscription data may also |
| | | contain DN-AAA Server addressing information. |
| | Edge Configuration Server | Consists of one or more FQDN(s) and/or IP |
| | Address Configuration | Address(es) of Edge Configuration Server(s) as |
| | Information | defined in clause 6.5.2 of TS 23.548 [74]. |
| | API based secondary | Indicates that whether the API based Secondary |
| | authentication indication | authentication/authorization (as defined in |
| | | clause 5.2.3 of TS 23.256 [80]) is required for |
| | | PDU Session Establishment as specified in |
| | | clause 4.3.2.3. (see NOTE 14). |
| | UE authorization for EAS | Indicates whether the UE is authorized to use |
| | discovery via EASDF | 5GC assisted EAS discovery via EASDF (as |
| | | defined in TS 23.548 [74]). |
| Identifier transition | SUPI | Corresponding SUPI for input GPSI. |
| | (Optional) MSISDN | Corresponding GPSI (MSISDN) for input GPSI |
| | | (External Identifier). This is optionally provided for |
| | | legacy SMS infrastructure not supporting |
| | | MSISDN-less SMS. The presence of an MSISDN |
| | | should be interpreted as an indication to the NEF |
| | | that MSISDN shall be used to identify the UE |
| | | when sending the SMS to the SMS-SC via T4. |
| | GPSI | Corresponding GPSI for input SUPI and |
| | | associated application information (e.g. |
| | | Application Port ID) (NOTE 15). |
| Intersystem continuity | (DNN, PGW FQDN) list | For each DNN, indicates the SMF + PGW-C which |
| Context | | support interworking with EPC. |
| LCS privacy | LCS privacy profile data | Provides information for LCS privacy classes and |
| (data needed by | | Location Privacy Indication (LPI) as defined in |
| GMLC) | | clause 5.4.2 in TS 23.273 [51] |
| LCS mobile | LCS Mobile Originated Data | When present, indicates to the serving AMF which |
| origination | | LCS mobile originated services are subscribed as |
| (data needed by | | defined in clause 7.1 in TS 23.273 [51]. |
| AMF) | | |
| User consent (see | User consent for UE data | Indicates whether the user has given consent for |
| TS 23.288 [50]) | collection | collecting, distributing, and analysing UE related |
| | | data. User consent is provided per purpose (e.g. |
| | | analytics, model training). |
| UE reachability | UE reachability information | Provides, per PLMN, the list of NF IDs or the list |
| | | of NF sets or the list of NF types authorized to |
| | | request notification for UE's reachability |
| | | (NOTE 7). |
| V2X Subscription | NR V2X Services Authorization | Indicates whether the UE is authorized to use the |
| data (see | | NR sidelink for V2X services as Vehicle UE, |
| TS 23.287 [73]) | | Pedestrian UE, or both. |
| | LTE V2X Services Authorization | Indicates whether the UE is authorized to use the |
| | | LTE sidelink for V2X services as Vehicle UE, |
| | | Pedestrian UE, or both. |
| | NR UE-PC5-AMBR | AMBR of UE's NR sidelink (i.e. PC5) |
| | | communication for V2X services. |
| | LTE UE-PC5-AMBR | AMBR of UE's LTE sidelink (i.e. PC5) |
| | | communication for V2X services. |
| ProSe Subscription | ProSe Service Authorization | Indicates whether the UE is authorized to use |
| data (see | | ProSe Direct Discovery, ProSe Direct |
| TS 23.304 [77]) | | Communication, or both and whether the UE is |
| | | authorized to use or serve as a ProSe UE-to- |
| | | Network Relay. |
| | ProSe NR UE-PC5-AMBR | AMBR of UE's NR sidelink (i.e. PC5) |
| | | communication for ProSe services. |
| MBS Subscription | MBS Service Authorization | Indicates whether the UE is authorized to use |
| data (see | | Multicast MBS service. May also indicate the |
| TS 23.247 [78]) | | multicast MBS Session which the UE is allowed to |
| | | join if the UE is authorized to use multicast MBS |
| | | Service. |

(NOTE 1):
The Subscribed DNN list can include a wildcard DNN.
(NOTE 2):
The default DNN shall not be a wildcard DNN.
(NOTE 3):
The Steering of Roaming information and UDM Update Data are protected using the mechanisms defined in TS 33.501 [15].
NOTE 4:
Framed Route information and Framed Route(s) are defined in TS 23.501 [2].
(NOTE 5):
Depending on the scenario PGW-C FQDN may be for S5/S8, or for S2b (ePDG case).
NOTE 6:
The Allowed PDU Session Types configured for a DNN which supports interworking with EPC should contain only the PDU Session Type corresponding to the PDN Type configured in the APN that corresponds to the DNN.
(NOTE 7):
Providing a list of NF types or a list of NF sets may be more appropriate for some deployments, e.g. in highly dynamic NF lifecycle management deployments.
(NOTE 8):
For a S-NSSAI and a DNN, the “Invoke NEF Indication” shall be present in the SMF selection subscription data if and only if the “NEF Identity for NIDD” Session Management Subscription Data includes a NEF Identity. When the “NEF Identity for NIDD” Session Management Subscription Data includes a NEF Identity for a S-NSSAI and DNN, the “Control Plane Only Indicator” will always be set for PDU Sessions to this S-NSSAI and DNN (see clause 5.31.4.1 of TS 23.501 [2]).
(NOTE 9):
When multiple GPSIs are included in the GPSI list, any GPSI in the list can be used in NSSAA procedures.
(NOTE 10):
The same PCF can be selected to serve the UE and to serve one or multiple PDU sessions, each of them is indicated in the list of S-NSSAI, DNN combinations in the PCF Selection Assistance Info. Providing one combination of DNN and S-NSSAI in the PCF Selection Assistance Info is assumed if interworking with EPS is needed. In case multiple PDU sessions to one DNN, S-NSSAI are established in EPS, it is appropriate to select same PCF by configuration or by using existing method, e.g. same PCF selection in usage monitoring.
(NOTE 11):
If Network Slice Simultaneous Registration Group information is present, and the VPLMN does not support the subscription-based restrictions to simultaneous registration of network slices, the subset of the Subscribed S-NSSAIs defined in clause 5.15.12 of TS 23.501 [2], are included, without providing the NSSRG information.
(NOTE 12):
The Default S-NSSAIs (if more than one is present) are associated with common NSSRG values if NSSRG information is present. At least one Default S-NSSAI shall be present in a subscription including NSSRG information.
(NOTE 13):
When UUAA is performed in the AMF (as in clause 5.2.2 of TS 23.256 [80]) and UUAA-MM status is FAILED or PENDING, the AMF shall reject PDU session establishment requests from the UE for a DNN that is subject to aerial services.
(NOTE 14):
For a DNN in S-NSSAI either a DN-AAA based secondary authentication, or an API based secondary authentication can be configured. When API based authentication of the PDU session is required, Secondary authentication indication shall not be present.
(NOTE 15):
A GPSI may be associated with Application Port ID, MTC Provider Information and/or AF Identifier.
(NOTE 16):
For non-roaming UE (e.g. accessing SNPN with CH credentials), LBO roaming information does not apply.

At least a mandatory key is required for each Subscription Data Type to identify the corresponding data. Depending on the use case, for some Subscription Data Types it is possible to use one or multiple sub keys to further identify the corresponding data, as defined in TS 23.502 V.17.4.0. For the Session Management Subscription data, the SUPI is the mandatory key, and network slice (S-NSSAI), Data network name (DNN), Serving PLMN ID and optionally Network identifier (NID) are defined as sub-keys.

### SUMMARY

Certain aspects of the present disclosure and their embodiments may provide solutions to the aforementioned or other challenges.

This present disclosure proposes a solution for conveying the offloading information (policies) to VPLMN in the HR-SBO scenario, where the offloading policy is pre-configured in the H-SMF, and it is indexed such that is becomes possible to derive the VPLMN-specific offloading policies based on offload IDs received from the UDM pointing to the corresponding configuration in the H-SMF.

The H-SMF applies the offload IDs as labels to the offloading policies sent to V-SMF, based on which it is possible that a specific offloading information is re-sent to the V-SMF only when needed, e.g., if the information has changed.

In accordance with some embodiment, a method performed a first session management function, SMF, e.g., a visited SMF in a visited PLMN of transferring policy information between a first network (visited PLMN) and a home network (home PLMN) of a User Equipment (UE) accessing Edge Hosting Environment (EHE) in the first network (e.g., a visited PLMN) is provided. The method comprises the first SMF (visited SMF) sending to a second SMF (home SMF) in the home network a request for a Packet Data Unit (PDU) session establishment for the UE indicating that the first SMF requests authorization for home routed session breakout (HR-SBO) for the PDU session and receiving by the first SMF (visited SMF) from the second SMF (home SMF) a message indicating a response including one or more offload identifiers (IDs), each ID of the one or more offload IDs identifying one or more first network-specific offload policies for Edge Computing (EC) services, to be applied at the first network.

For example, the message indicating the response further comprises at least one of the one or more first network-specific offload policies that are identified by at least one of the one or more offload IDs.

For example, the request for the PDU session establishment includes one or more previously provisioned offload IDs identifying one or more previously provisioned first network-specific offload policies at the first network from the home network. This may be include to indicate to the home network which offload policies are available at the first network. The one or more previously provisioned offload IDs may be tagged with a timestamp indicating when the one or more previously provisioned first network-specific offload policies was provisioned at the first network. If for example, the offload policies associated to the previously provisioned offload IDs included in the request for the PDU session are update, the message indicating the response further comprises the one or more previously provisioned offload IDs with corresponding updated first network-specific offload policies. If updated policies or new offload policies are received, the first SMF replaces the one or more previously provisioned first network-specific offload policies with the updated first network-specific offload policies corresponding to the one or more previously provisioned offload IDs. The first SMF also stores any new received policies with their corresponding offload identifier.

According to some examples, the one or more offload IDs in the message correspond to one or more subscription offload IDs obtained from subscription data for the UE, and/or one or more generated offload IDs that are generated based on the one or more subscription offload IDs and the one or more previously provisioned offload IDs included in the request for the PDU session establishment.

In one example, the first network-specific offload policies or the updated first network-specific policies include for allowed Edge Computing services and/or non-allowed Edge computing services one or more Fully Qualified Domain Names (FQDNs) and/or a range of Internet Protocol (IP) addresses.

According to some examples, the provided method further comprises the step of configuring a User Plane Function in the first network (visited PLMN) with an uplink classifier branch point (UL CL/BP) with the first network-specific offload policies and/or updated offload policies.

Similarly, a method of transferring policy information between a first network (visited PLMN) and a home network of a User Equipment (UE) accessing Edge Hosting Environment (EHE) in the first network, where the method is implemented in a second session management function (SMF) in the home network (H-SMF) is provided. The method comprises receiving by the second SMF (H-SMF) from a first SMF (V SMF) in the first network (VPLMN) a request for a PDU session establishment indicating that the first SMF requests authorization for home routed session breakout (HR-SBO) of the PDU session, and obtaining from a third network function a first network-specific traffic offload information that includes subscribed one or more offload Identifiers (IDs) for policies of one or more Edge Computing (EC) services allowed for HR-SBO, and/or subscribed one or more Offload IDs for policies of one or more Edge Computing (EC) services Not-allowed for HR-SBO, and finally sending to the first SMF in the first network (visited PLMN) a message indicating a response including one or more offload IDs wherein the one or more offload IDs are based on the subscribed one or more offload IDs to be applied by the first network.

In one example the policies (same as previously referred first network-specific offload policies) correspond to at least one of a list of Fully Qualified Domain Names (FQDNs) and destination IP ranges. The one or more offload IDs may correspond directly to the subscribed one or more offload IDs or may be generated based on the subscribed one or more offload identifiers and an identifier of the first network.

In one example, the method further comprises the step of retrieving by the second SMF (H-SMF) the policies for each of the one or more offload identifiers from an internal configuration of the second SMF or from a policy server in the home network and if retrieved, the second SMF (H-SMF) includes them in the message to the first SMF (V-SMF), the message indicating a response to the request for the PDU session establishment.

The request for the PDU session establishment may also include one or more previously provisioned offload IDs identifying any previously provisioned one or more offload policies at the first SMF which may be tagged with a timestamp indicating when the identified offload policies were provisioned. If the second SMF determines the policies associated to the one or more previously provisioned offload IDs need to be updated at the first SMF, it sends the updated policies in the message indicating a response to the first SMF so the first SMF can update the policies for the offload IDs.

According to some embodiment, a network node or server adapted to perform the method of any one of the embodiments described herein is provided.

According to other embodiments, a network node or server that comprises one or more processors and memory comprising instructions which when executed by the one or more processors configures the network node or server to perform the method of any one of the embodiments described herein is provided.

According to other embodiments, a non-transitory computer-readable storage medium that includes executable instructions that when executed by a processor cause the processor to perform any one of the embodiments described herein is provided.

### BRIEF DESCRIPTION OF THE DRAWINGS

The accompanying drawing FIGURES incorporated in and forming a part of this specification illustrate several aspects of the present disclosure, and together with the description serve to explain the principles of the present disclosure.

FIG. 1 illustrates one example of a wireless communications system in which embodiments of the present disclosure may be implemented;

FIG. 2 illustrates one example of a core network of a wireless communications system in which embodiments of the present disclosure may be implemented;

FIG. 3A illustrates another example of a core network of a wireless communications system illustrating 5G System (5GS) providing access to EAS with UL CL/BP for non-roaming scenario;

FIG. 3B illustrates another example of a core network of a wireless communications system illustrating 5G System (5GS) providing access to EAS without UL CL/BP for non-roaming scenario;

FIG. 4 illustrates one example of a 5G Architecture for Home Routing Session Breakout in Visited PLMN;

FIG. 5 illustrates a procedure for PDU Session supporting HR-SBO in VPLMN;

FIG. 6 illustrates detailed procedure for PDU Session establishment in accordance with the embodiments of this disclosure.

FIGS. 6A and 6B illustrate flow charts of methods performed by first and second session management functions in accordance with the embodiments of this disclosure.

FIGS. 7, 8, and 9 are schematic block diagrams of example embodiments of a network node.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Although the embodiments are described using a 5G core network, it will be apparent to a person skilled in the art that any core network that supports edge computing can implement these embodiments, including 4G, 6G and beyond.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node or server in a core network or any node or server. Some examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like. A Network Function (NF) may be implemented either as a network element on a dedicated hardware, as a software instance running on a dedicated hardware, or as a virtualized function instantiated on an appropriate platform, e.g., a cloud infrastructure. One or more network functions may be implemented or hosted on the same node/server or may be distributed across multiple nodes/servers.

Communication Device: As used herein, a “communication device” is any type of device that has access to an access network. Some examples of a communication device include, but are not limited to: a mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

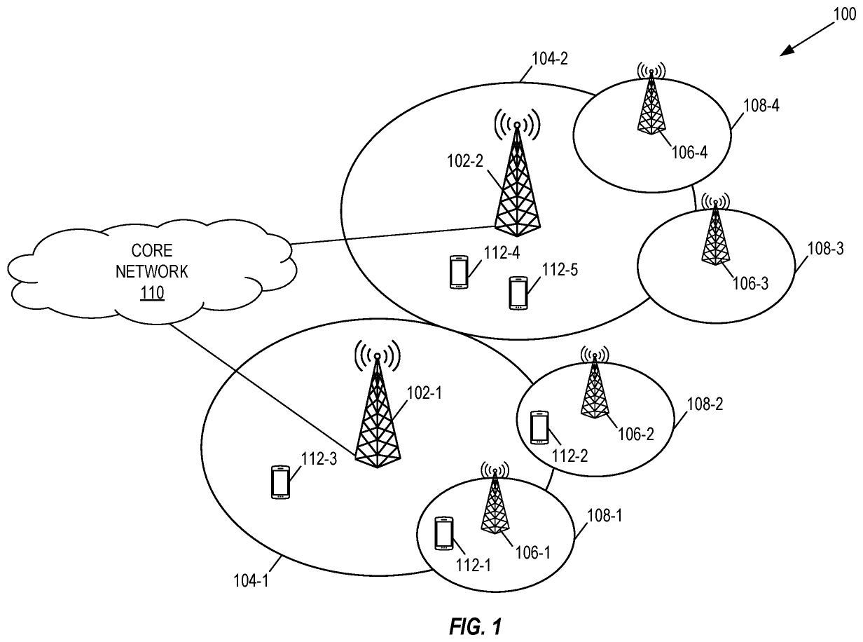

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the RAN includes base stations 102-1 and 102-2, which in the 5GS include NR base stations (gNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

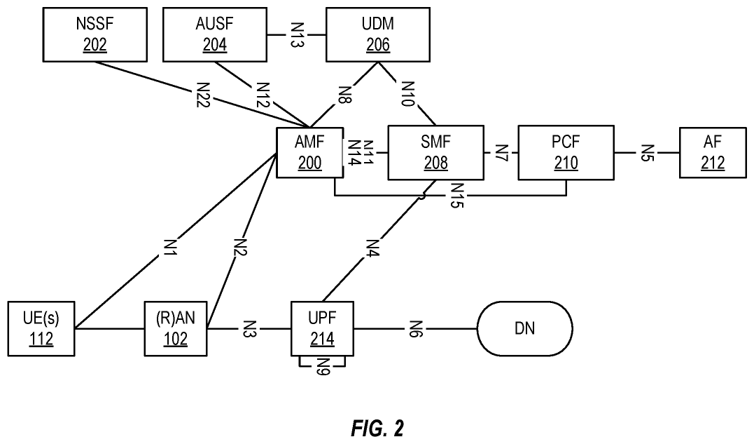

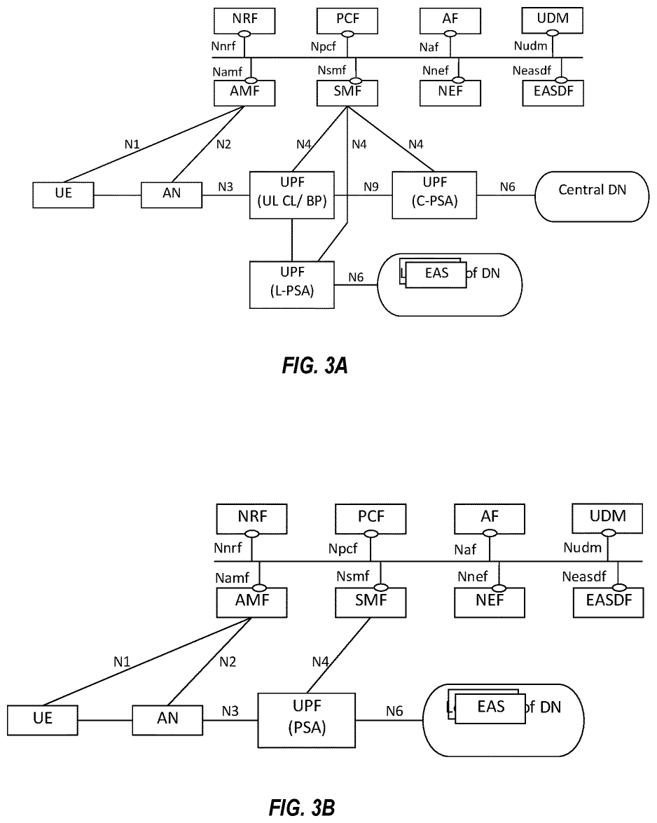

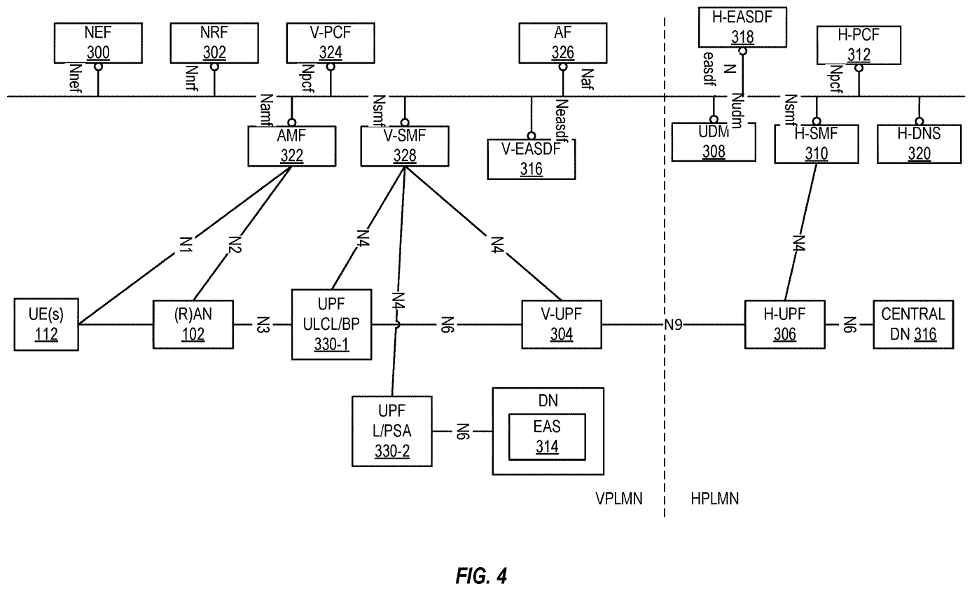

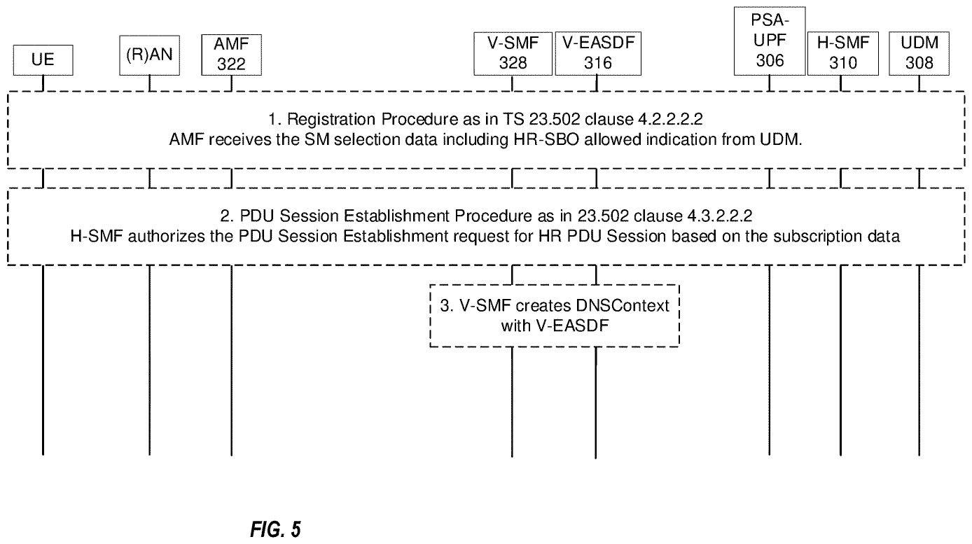

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the cellular communications system 100 of FIG. 1.

A Network Function (NF) may be implemented either as a network element on a dedicated hardware, as a software instance running on a dedicated hardware, or as a virtualized function instantiated on an appropriate platform, e.g., a cloud infrastructure.

Seen from the access side the 5G network architecture shown in FIG. 2 comprises a plurality of UEs 112 connected to either a RAN 102 or an Access Network (AN) as well as an AMF 200. Typically, the R (AN) 102 comprises base stations, e.g., such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, Policy Control Function (PCF) 210, AF 212, Network Slice Selection Function (NSSF) 202, Authentication Server Function (AUSF) 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

### 3GPP TR 23.700-48 Lists Two Main Scenarios in Clause 5.1.2:

2.1) HPLMN has the knowledge of EAS deployment information in VPLMN for specific services. The HPLMN triggers EAS discovery and local traffic routing in VPLMN.
2.2) HPLMN does not have the knowledge of EAS deployment information in VPLMN. The VPLMN triggers EAS discovery and local traffic routing in VPLMN.

The most difficult from the perspective of sending traffic offload information, aka VPLMN-specific offload policy is scenario 2.1. The main issue with this scenario is that since the HPLMN knows the EDI (Edge Deployment information, as specified in TS 23.548 and included by reference herein) this assumes that the HPLMN is in a business relation with the EC (Edge Computing) service provider.

In various embodiments disclosed herein, the UDM could be used to indicate proper references to the H-SMF to select the required VPLMN-specific offload policies.

The amount of information exchanged between the HPLMN and VPLMN may be reduced.

According to embodiments presented herein, the following offload information needs to be conveyed to the VPLMN for Home Routed-Session Break Out (HR-SBO). Session Breakout uses Uplink classifier, or IPv6 branching point as per TS 23.501) in this case
1. Authorization from HPLMN for HR-SBO
2. Policies related to the PDU Session, such as AMBR
3. Information based on which VPLMN could perform the UL CL/BP and local PSA selection.
4. Other potential service SLA-related information.

### Regarding Point 3 Above, the Following Alternatives are Seen Regarding the Conveyed Information to Support Session Breakout:

1. All information needed (including EDI as defined in TS 23.548) is conveyed. This is to support full-fledged EAS re-discovery procedures as in TS 23.548. This means conveying a large volume of information, like EDI, which is not (normally) PDU session related information, for each PDU Session. Providing the EDI related to VPLMN topology to HPLMN assumes that the SP has service agreements both with VPLMN and HPLMN. This is because VPLMN DNAIs in EDI should be agreed on and exchanged between the Service providers (SPs) and the VPLMN first, and only then the SPs can provide EDI related to VPLMN DNAIs to HPLMN. The same chain of communication is required also when VPLMN DNAIs are changed.
2. The offload policy information includes the EC FQDNs and (optionally) IP ranges to be configured in UL CL/BPs. In this case V-SMF selects the UL CL or BP and L-PSA based on UE location without considering the EAS deployment information. This is proposed in solutions #02, #03, #05 and #25 from TR 23-700-48.

According to the proposed embodiments, this information should be stored in the H-SMF and indexed properly. In the case if EDIs from point 1 above, each EDI is stored separately and indexed. Similarly, the offload policy information from point 2 above can also be indexed. One example is shown in Table 2 below.

TABLE 2
FQDNs and IP address ranges for the allowed EC
services indexed according to the EC service

| | | | | |
|---|---|---|---|---|
| Offload_ID_A: | FQDN_1, . . . , | IP range_1, . . . , | Latency A | . . . |
| | FQDN_K | IP range_n | | |
| Offload_ID_B: | FQDN_K + 1, | IP range_n + | Latency B | . . . |
| | . . . , FQDN_M: | 1, . . . , | | |
| | | IP range_p | | |

In the proposed embodiments, illustrated in Table 2, the different rows in the table tagged with Offload_ID_A, B, etc. would correspond to the traffic offload policies for a specific EC service, so the FQDNs can be used to provision V-EASDF in the case of session break out by means of DNS-based EAS discovery, while the list of IP ranges are the list of EAS IP ranges that are authorized to be used for a given service in the UL CL/BP.

Note that this service-related offload information A, B, etc., is independent of the VPLMN, although some EAS IP ranges will never be configured for a certain VPLMN as they represent service provider deployments in different countries and PLMNs (assuming that UL CL configuration update for a given IP address range happens when the DNS response contains both the ECS and an EAS IP address belonging to the given IP address range).

In an example, each row in Table 2 into the country specific IP address ranges, and then the keys A1, A2, B1, B2, etc. would identify both the service and the geographical regions (e.g., MCC) relevant for the IP ranges. This is shown in Table 3 below. Note that the offload IDs A1, A2, B1, B2, etc, may be derived based on the offload ID for the service and the VPLMN ID, respectively.

TABLE 3
FQDNs for the allowed EC services indexed according to
the EC service coupled with IP address ranges using MCC

| | | | | |
|---|---|---|---|---|
| Offload_ID_A: | FQDN_1, . . . , | | Latency A | . . . |
| | FQDN_K | | (optional) | |
| Offload_ID_A1 | | IP range_1, . . . , | | |
| | | IP range_x | | |
| Offload_ID_A2 | | IP range_x + | | |
| | | 1, . . . , IP | | |
| | | range_y | | |
| Offload_ID_B: | FQDN_K + 1, | | Latency B | . . . |
| | . . . , FQDN_M: | | (optional) | |
| Offload_ID_B1 | | IP range_y + | | |
| | | 1, . . . , IP | | |
| | | range_z | | |
| Offload_ID_B2 | | IP range_z + | | |
| | | 1, . . . , IP | | |
| | | range_t | | |

The information structures as proposed in Table 2 and Table 3 do not require VPLMN DNAIs, so this approach simplifies the information exchanged between all parties (VPLMN DNAIs in EDI to HPLMN require that Home MNO understands the VPLMN DNAIs, that HPLMN shares them with the Service providers (SPs) it has agreements with, and that SPs provide EDI related to VPLMN DNAIs and modify it if VPLMN DNAIs change). It also reduces the information H-SMF needs to provide to V-SMF.

The above indicates that the VPLMN-specific offload policy could include traffic descriptors (FQDNs and IP address ranges) that are allowed HR-SBO.

The VPLMN-specific offload policy may have different composition, depending on which MNO the Service Provider (SP) is in contract with.

If there is an agreement between the SP and the VPLMN, then EC Application information (e.g., EDIs) is available in VPLMN. In this case, the HPLMN may, as a minimum, provide only the HR-SBO authorization indication to the VPLMN. However, it could be that HPLMN provides other services for the given UE and PDU Session, for other, non-EC applications. If that is the case, then these applications should not be allowed for SBO in VPLMN. Hence, VPLMN-specific offload policy may include traffic descriptors (e.g., destination IP ranges, ports, FQDNs) that are not allowed for HR-SBO.

Table 4 contains an example of how to extend the Session Management Subscription data based on the existing UE Subscription data (i.e., Table 5.2.3.3.1-1 in TS 23.502) as shown in Table 1. The data could be extended with the following information:

TABLE 4
Proposed HR-SBO related additional Session Management Subscription data to existing
UE Subscription data (i.e., to Table 5.2.3.3.1-1 in TS 23.502 V.17.4.0)

| Subscription data | | |
|---|---|---|
| type | Field | Description |
| Session Management | For each serving PLMN and DNN in S-NSSAI level subscription data: | |
| Subscription data | Authorization for HR-SBO | Indicates whether this serving PLMN is authorized |
| (additional data for | | to use HR-SBO for the HR-PDU Session |
| HR-SBO) | Allowed services for HR-SBO | Consists of one or more Offload Identifiers for the |
| | | list of FQDNs and/or destination IP ranges of one |
| | | or more EC services allowed for HR-SBO |
| | Not allowed services for HR- | Consists of one or more Offload Identifiers for the |
| | SBO | list of FQDNs and/or destination IP ranges of one |
| | | or more EC service not allowed for HR-SBO |

Each Offload Identifier identifies a service consisting of a list of FQDNs and/or a list of IP address ranges as defined in Table 2 or Table 3 above. Hence, it is enough in some embodiment that the Offload Identifiers be sent by the H-SMF to the V-SMF rather than the whole information. By doing so, the amount of information exchanged between the HPLMN and VPLMN may be reduced.

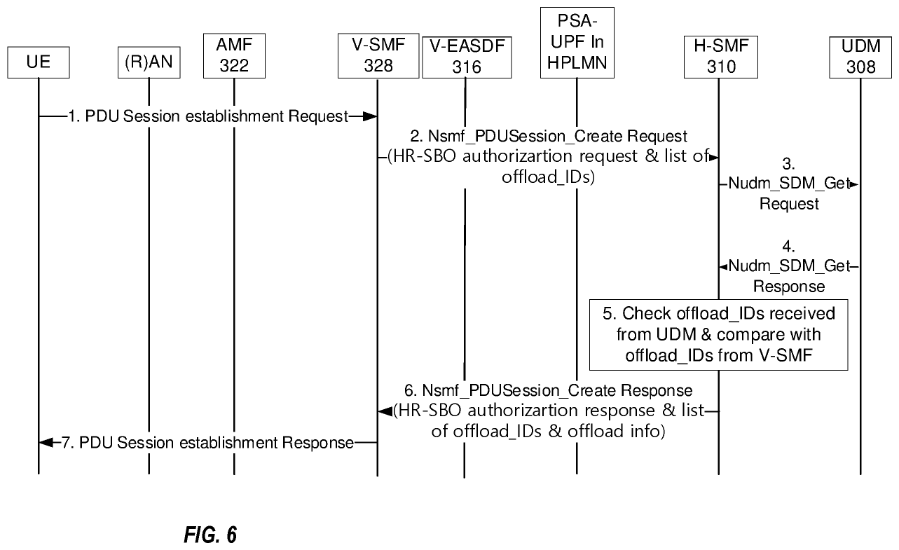

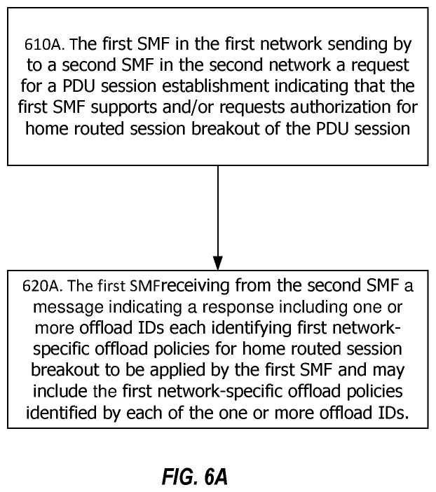

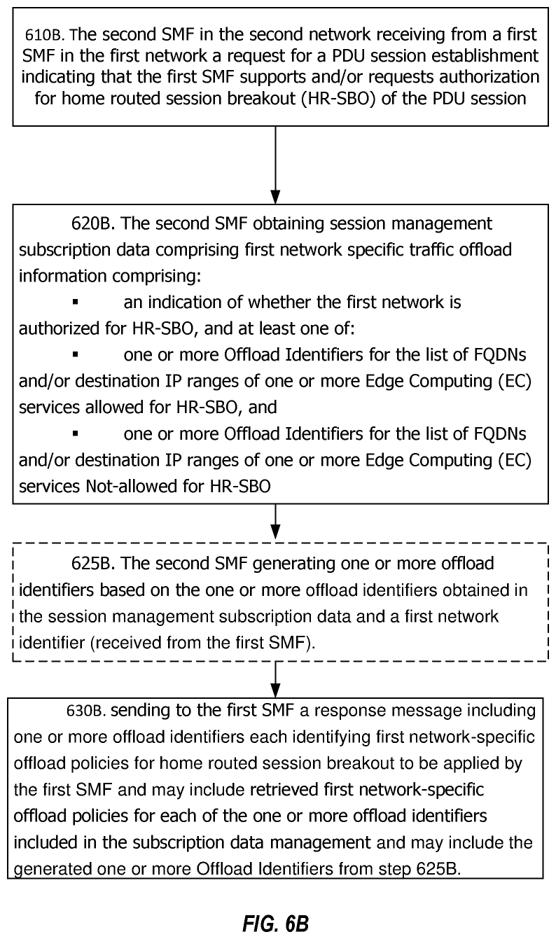

FIG. 6 illustrates a procedure for PDU Session establishment in accordance with the embodiments of this disclosure.
Step 1: UE sends PDU Session establishment request to V-SMF 328 selected by the AMF 322.
Step 2: V-SMF 328 selects UPF in VPLMN (that could be based on the policies fetched from V-PCR) and sends Nsmf_PDUSession_Create Request to H-SMF 310, in which it send the support for and/or authorization request for HR-SBO, and also provides the V-EASDF 316 address to H-SMF 310. The V-SMF 328 also sends the offload IDs for the offload information previously received from H-SMF 310 (if any) and which may be tagged with a timestamp on when they were received.
Step 3: H-SMF 310 requests the Session Management Subscription data using Nudm_SDM_Get (SUPI, Session Management Subscription data, selected DNN, S-NSSAI of the HPLMN, Serving PLMN ID, [NID]) and subscribes to be notified when this subscription data is modified using Nudm_SDM_Subscribe.
Step 4: UDM 308 responds with the Session Management Subscription data. The data includes the VPLMN-specific traffic offload information e.g., as shown in Table 4 in accordance with the embodiments of this disclosure.
Step 5: The H-SMF 310, then checks the offload IDs received in the VPLMN-related offload information from the UDM 308, and it may generate further offload IDs from the offload IDs received from the UDM 308 and the VPLMN ID indicated in the request from the V-SMF 328. A non-limiting example of how the H-SMF 310 could generate the offload IDs, comprises using an algorithm to derive the Mobile country code (MCC) from the received VPLMN ID, then could use generate an offload identifier from
   the offload identifier received from the subscription server (e.g., UDM 308) (describing the FQDNs of the EC service) and
   the MCC that is derived from the VPLMN iD
      The generated offload identifier then would identify the IP address ranges in the traffic offload policy for the given EC service that belong to the geographical region identified by the MCC. The generated offload identifiers would consequently be derived per region in a certain country based on the above generation algorithm.
      Note that in this way the same identifier may result for different VPLMNs in a certain country. These offload IDs may be used to identify the EAS IP address ranges for an EC service in a geographical region, e.g., MCC of VPLMN, as shown in Table 2.

The H-SMF 310 may compare the offload IDs from the subscription and the further generated ones) with the offload IDs when received from the V-SMF 328. It may also checks based on the timestamp received whether configuration information (i.e., offload policies) has been changed for some of the offload IDs received from the UDM 308 related information or offload IDs generated by the H-SMF 310.

Step 6: the H-SMF 310 sends Nsmf_PDUSession_Create Response to V-SMF 328, where, it includes the VPLMN-specific offload policies (including also the related offload IDs). The related offload IDs may include:
offload IDs received from the UDM and/or generated by the H-SMF 310 with corresponding offload policies (optional), and not the offload IDs received from the V-SMF 328 if no update to the corresponding policies is required, or
offload IDs received from the UDM 308 and/or generated by the H-SMF 310 with the corresponding offload policies (optional), and the offload IDs received from the V-SMF if there has been an update to the corresponding policies in the meantime, and the related updated policy info.
Alternatively, the response includes all the offload IDs and corresponding offload policies info which will overwrite all the offload policies in the V-SMF 328. Alternatively, when no update is required to the policies for the V-SMF provided offload IDs, the response may include the offload Ids and the related offload policies info (from the subscription and/or generation) or it may just include the V-SMF 328 provided offload IDs of the unchanged policies already available in the V-SMF 328, to indicate to the V-SMF 328 that the unchanged policies are still valid. It is apparent to a person skilled in the art that any combination of add, update or remove of offload policies from the H-SMF 310 to the V-SMF 328 with related offload Ids are supported.

Step 7: The V-SMF stores any offload policies (if received) and offload IDs provided by the H-SMF 310 and sends the PDU Session establishment response to the UE.

The procedure described herein is described between a home PLMN and a visited PLMN, and a visited SMF and Home SMF, however the embodiment of FIG. 6 may also be implemented between SMFs in a non-public network (NPN) and a PLMN.

FIG. 6A is a flowchart illustrating the method performed by a first SMF in a first network initiating a PDU session establishment request to a second SMF in a second network. The first SMF is exemplified as a visited SMF (V-SMF) in a visited PLMN, the second SMF is exemplified as a home SMF (H-SMF) in a HPLMN, but it is not limited thereto.

At step 610A, When the first SMF receives a PDU session establishment request from an AMF for a UE, the AMF may indicate to the first SMF that the requested session is allowed for HR-SBO. After the first SMF selects UPF in VPLMN (that could be based on the policies fetched from a PCF in the first network) and sends Nsmf_PDUSession_Create Request to a second SMF in the second network, it include the support for and/or authorization request for HR-SBO. The first SMF also provides the V-EASDF address to H-SMF. If any, the first SMF also includes the offload IDs for the offload policies that are previously provisioned. The offload IDs can be tagged with a timestamp indicating when the corresponding policies were received and provisioned.

At step 620A, the first SMF receives Nsmf_PDUSession_Create Response from the second SMF. The Response includes one or more offload IDs each identifying first network-specific offload policies for home routed session breakout to be applied by the first SMF.

The Response may further comprise the first network-specific offload policies identified by each of the one or more offload IDs, where the one or more offload IDs correspond to the offload IDs from subscription data or offload IDs generated from these offload IDs.

If the PDU session establishment request in 610A included one or more previously provisioned offload IDs and optionally the timestamp of when the corresponding policies were received or provisioned, the Response comprises at least one of:
the one or more previously provisioned offload IDs (as included in the request step 610A) and the corresponding updated offload policies; and
the one or more first network-specific policies and the related offload identifiers corresponding to the offload identifiers obtained or generated from subscription data.

In another example, the first SMF may also receive a Response that does not contain any specific offload policies and related offload IDs. If the V-SMF has included in the Request in step 610A existing or previously provisioned offload IDs, the V-SMF may interpret the response that does not include any updated offload policies for the related offload IDs as maintaining any existing offload policies and related offload IDs, i.e., the previously offload policies have not yet expired.

Alternatively, the Response may include the previously provisioned offload IDs as included in the request without corresponding offload policies info as an acknowledgement by the second SMF that those previously provisioned offload policies are still valid. The first SMF interprets that the same policies corresponding to the previously provisioned offload IDs should be used.

The first SMF stores and enforce any received offload policies with related offload identifiers.

The offload policies info includes the EC FQDNs and (optionally) IP ranges to be configured in UL CL/BPs for the allowed and/or non-allowed Edge computing (EC) services. In this case the first SMF selects the UL CL or BP and L-PSA based on UE location without considering the EAS deployment information. In addition, other information that may be conveyed in the response include the EDI defined in TS 23.548. This is to support full-fledged EAS re-discovery procedures as in TS 23.548. This means conveying a large volume of information, like EDI, which is not (normally) PDU session related information, for each PDU Session. Providing the EDI related to the first network (e.g., VPLMN) topology to the second network (e.g., HPLMN) assumes that the SP has service agreements with both with the first and second network, e.g., VPLMN and HPLMN. This is because the first network DNAIs in EDI should be agreed on and exchanged between the Service providers (SPs) and the first network first, and only then the SPs can provide EDI related to first network DNAIs to the second network. The same chain of communication is required also when the first network DNAIs are changed. The first SMF updates and stores the offload IDs and their corresponding offload policy information as received from the second SMF. The first SMF sends PDU Session establishment response to the UE and enforces the policies for HR-SBO.

FIG. 6B is a flowchart illustrating the method performed by a second SMF in a second network providing first network-specific policies to a first SMF in a first network during a PDU session establishment procedure. The first SMF is exemplified as a visited SMF in a visited PLMN, the second SMF is exemplified as a home SMF in a HPLMN, but it is not limited thereto.

At step 610B, the method comprises the step of receiving from a first SMF in the first network a request for a PDU session establishment that includes an indication that the first SMF supports and/or requests authorization for home routed session breakout (HR-SBO) from the second SMF in the second network. At step 620B, the second SMF, proceeds by obtaining session management subscription data from a subscription server such a UDM. The subscription data comprises the first network specific traffic offload information comprising information in table 4 above), i.e.:
an indication of whether the first network is authorized for HR-SBO, either one or both of:
   one or more Offload Identifiers for the list of FQDNs and/or destination IP ranges of one or more Edge Computing (EC) services allowed for HR-SBO, and
   one or more Offload Identifiers for the list of FQDNs and/or destination IP ranges of one or more Edge Computing (EC) services Not-allowed for HR-SBO.
      The UDM only needs to indicate to the second SMF the offload identifiers but does not need to provide the offload policies themselves.

Optionally, at step 625B, the second SMF may generate further offload IDs from the offload ID received from the subscription server (e.g., UDM) and the first network ID (e.g., VPLMN ID) which is indicated in the request from the first SMF (as explained above). These further generated offload IDs may be used to identify the EAS IP address ranges for an EC service in a geographical region, e.g., MCC of the first network (e.g., VPLMN), as shown in Table 2. The offload policies indexed by the offload identifiers (from the subscription or generated) are configured in the second SMF. Alternatively, the second SMF may retrieve the offload policies from a storage or a server such as a policy server by using the offload identifier(s) as an index (indices) to the offload policies it needs.

At step 630B, the second SMF sending to the first SMF a response message including the one or more offload identifiers each identifying the first network-specific offload policies for home routed session breakout to be applied by the first SMF as obtained from the subscription server and/or the one or more further generated offload identifiers by the second SMF based on the offload identifiers received in the subscription data each identifying the first network-specific offload policies for home routed session breakout to be applied by the first SMF. The message may also include the retrieved related offload policies for the related one or more offload identifiers (subscription and/or generated).

In one example, the method further comprises receiving in the request for the PDU session establishment one or more previously provisioned offload Identifiers identifying previously provisioned one or more first network-specific offload policies at the first SMF in the first network, where each of the one or more previously provisioned offload Identifiers is optionally tagged with a timestamp indicating when the identified first network-specific offload policy was provisioned.

In one example, subsequent to receiving in the request for the PDU session establishment one or more previously provisioned offload Identifiers and once the session management subscription data is received with the one or more offload identifiers (step 620B), the second SMF may generate further offload identifier(s) from the offload identifiers received in the session management subscription data and the VPLMN ID. The second SMF, then, determining whether the one or more previously provisioned offload identifiers received from the first SMF are the same or different from the one or more offload identifiers included in the session management subscription data and/or those further generated. In this example, the only criteria is matching of the offload identifiers. If the identifiers are the same or match, the second SMF retrieving the one or more first network-specific offload policies corresponding to the matched one or more offload identifiers. However, the second SMF also retrieves for the non-matched one or more offload identifiers the corresponding offload policies for the offload identifiers included in the subscription data/or further generated. The second SMF then includes in the response message to the first SMF the retrieved one or more first network-specific offload policies for each of the associated one or more offload identifiers, i.e., for both matched and unmatched offload identifiers included in the subscription data/further generated (when any).

In another example, subsequent to receiving in the request for the PDU session establishment one or more previously provisioned offload Identifiers including the timestamps and once the session management subscription data is received with the one or more offload identifiers (step 620B), and optionally generating further offload identifiers based on the session management subscription data and first network identifier (see above), the second SMF in the second network determining whether the one or more previously provisioned offload identifiers received from the first SMF are the same (i.e., match) or different from the one or more offload identifiers received in the session management subscription data and/or the one or more offload identifiers further generated by the second SMF as explained above.

If in this other example, the offload identifiers are the same/matching, the second SMF determining if the timestamp provided with the one or more previously provisioned offload identifiers indicate that the corresponding previously provisioned first network-specific offload policies have expired or need to be updated, and in response to determining that the one or more previously provisioned first network-specific offload policies have expired or need to be updated, the second SMF proceeds by retrieving the one or more updated first network-specific offload policies for the matched one or more offload identifiers (subscription/further generated offload identifiers). But in response to determining that the one or more previously provisioned first network-specific offload policies have not expired or do not need to be updated, the second SMF does not need to retrieve the one or more first network-specific offload policies for the matched one or more offload identifiers as those policies are assumed to still be valid in the first SMF. The second SMF proceeds by including in the message indicating the response at least one of:
the retrieved one or more updated first network-specific offload policies for each of the associated one or more offload identifiers that match with the one or more previously provisioned offload identifiers included in the request.
and any retrieved one or more first network-specific policies for the one or more unmatched offload identifiers obtained from the subscription data and/or for the further generated offload identifiers by the second SMF.

In yet another example, subsequent to receiving in the request for the PDU session establishment one or more previously provisioned offload Identifiers including the timestamps and once the session management subscription data is received with the one or more offload identifiers (step 620B), and optionally generating further offload identifiers based on the offload identifiers included in the session management subscription data and first network identifier included in the request from the first SMF (see above), the second SMF in the second network determining whether the one or more previously provisioned offload identifiers received from the first SMF are the same (i.e., match) or different (unmatched) from the one or more offload identifiers received in the session management subscription data and/or further generated by the second SMF. If the second SMF determines the offload identifiers are different/unmatching, the second SMF determining if the timestamp provided with the one or more previously provisioned offload identifiers indicate that the corresponding one or more previously provisioned first network-specific offload policies have expired or need to be updated. In response to determining that the one or more previously provisioned first network-specific offload policies have expired or need to be updated, the second SMF in this yet another example retrieves the one or more updated first network-specific offload policies for the expired policies and retrieving the one or more first network-specific offload policies for the one or more offload identifiers from the session management subscription data and/or the further generated one or more offload identifiers. Furthermore, in response to determining that the one or more previously provisioned first network-specific offload policies have not expired, the second SMF would only retrieve the one or more first network-specific offload policies for the one or more offload identifiers from the session management subscription data (in this case all the offload identifiers do not match the offload identifiers included in the PDU session request) and the second SMF proceeds by including in the response to the first SMF at least one of:
the retrieved one or more first network-specific offload policies for each of the associated one or more offload identifiers from the subscription data and/or for each of the further generated offload identifiers by the second SMF
the retrieved one or more updated first network-specific offload policies for each of the associated one or more previously provisioned offload identifiers indicated as expired.

In another example, subsequent to receiving in the request for the PDU session establishment one or more previously provisioned offload Identifiers which may or may not include the timestamps and once the session management subscription data is received with the one or more offload identifiers (step 620B), and optionally generating further offload identifiers based on the offload identifiers included in the session management subscription data and first network identifier included in the request from the first SMF (see above) the second SMF in the second network determining whether the one or more previously provisioned offload identifiers received from the first SMF are the same (i.e., match) or different from the one or more offload identifiers received in the session management subscription data and/or further generated by the second SMF. If the second SMF determined they are different/unmatching, retrieving by the second SMF (from configuration, storage or server, e.g., PCF) the one or more first network-specific offload policies for the one or more offload identifiers included in the session management subscription data and including in the PDU session establishment response message to the first SMF information indicating the retrieved one or more first network-specific offload policies for each of the associated one or more offload identifiers from the subscription data and/or or each of the associated one or more offload identifiers generated by the second SMF.

In some examples, the first network-specific offload policies include one or more Fully Qualified Domain Names (FQDNs) and optionally a range of Internet Protocol (IP) addresses for the allowed and/or non-allowed Edge Computing services.

Other information that may be included as part of the offload policies that are either stored, retrieved and provided by the second SMF to the first SMF include the EDI defined in TS 23.548. This is to support full-fledged EAS re-discovery procedures as in TS 23.548. This means conveying a large volume of information, like EDI, which is not (normally) PDU session related information, for each PDU Session. Providing the EDI related to first network (e.g., VPLMN) topology to the second network (e.g., HPLMN) assumes that the SP has service agreements with both the first network and second network (e.g., VPLMN and HPLMN). This is because the first network/VPLMN DNAIs in EDI should be agreed on and exchanged between the Service providers (SPs) and the first network/VPLMN first, and only then the SPs can provide EDI related to first network/VPLMN DNAIs to HPLMN. The same chain of communication is required also when first network/VPLMN DNAIs are changed. The first SMF updates and stores the offload IDs and their corresponding offload policy information as received from the second SMF. The first SMF sends PDU Session establishment response to the UE and enforces the policies for HR-SBO.

As previously indicated the first and second network are not limited to a VPLMN and HPLMN, the embodiments may be applied between a PLMN and an NPN and potentially between two NPNs.

In another embodiment, the subscription server, e.g., UDM in 5G, maintains and provides subscription data to an SMF. The subscription data may be maintained in a UDR (repository) and retrieved from UDM when requested by a consumer such as an SMF. The session management subscription data is extended to include additional data for HR-SBO. The information is stored for each serving PLMN and DNN in a network slice. The details of the subscription data is illustrated in Table 4.

The UDM provides the subscription data when requested or when it is modified if the consumer (SMF) subscribed to be notified for any changes.

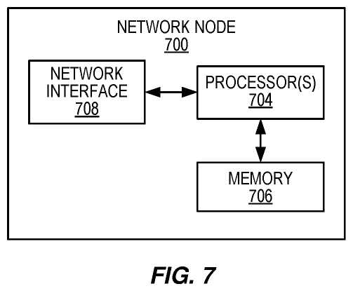

FIG. 7 is a schematic block diagram of a network node 700 according to some embodiments of the present disclosure. Optional features are represented by dashed boxes. The network node 700 may be, for example, a core network node that implements a NF (e.g., AMF 200, SMF 208, V-SMF 328, UL CL/BP 330-1, V-EASDF 316, H-SMF 310, UDM 308, H-DNS 320, or H-EASDF 318) or a network node that implements all or part of the functionality of an NF (e.g., all or part of the functionality of the AMF 200, SMF 208, V-SMF 328, UL CL/BP 330-1, V-EASDF 316, H-SMF 310, UDM 308, H-DNS 320, or H-EASDF 318 described herein). As illustrated, the network node 700 includes a one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. The one or more processors 704 operate to provide one or more functions of the network node 700 as described herein (e.g., one or more functions of the AMF 200, SMF 208, V-SMF 328, UL CL/BP 330-1, V-EASDF 316, H-SMF 310, UDM 308, H-DNS 320, or H-EASDF 318 described herein). In some embodiments, the function(s) are implemented in software that is stored, e.g., in the memory 706 and executed by the one or more processors 704.

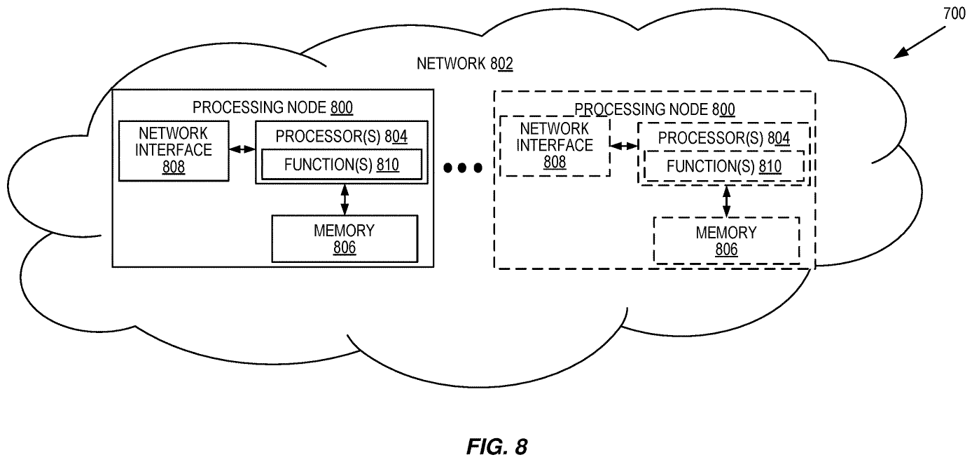

FIG. 8 is a schematic block diagram that illustrates a virtualized embodiment of the network node 700 according to some embodiments of the present disclosure. Again, optional features are represented by dashed boxes. As used herein, a “virtualized” network node is an implementation of the network node 700 in which at least a portion of the functionality of the network node 700 is implemented as a virtual component(s) (e.g., via a virtual machine(s) executing on a physical processing node(s) in a network(s)). As illustrated, in this example, the network node 700 includes one or more processing nodes 800 coupled to or included as part of a network(s) 802. Each processing node 800 includes one or more processors 804 (e.g., CPUs, ASICs, FPGAS, and/or the like), memory 806, and a network interface 808. In this example, functions 810 of the network node 700 described herein (e.g., one or more functions of the AMF 200, SMF 208, V-SMF 328, UL CL/BP 330-1, V-EASDF 316, H-SMF 310, UDM 308, H-DNS 320, or H-EASDF 318 described herein) are implemented at the one or more processing nodes 800 or distributed across the two or more processing nodes 800 in any desired manner. In some particular embodiments, some or all of the functions 810 of the network node 700 described herein are implemented as virtual components executed by one or more virtual machines implemented in a virtual environment(s) hosted by the processing node(s) 800.

In some embodiments, a computer program including instructions which, when executed by at least one processor, causes the at least one processor to carry out the functionality of the network node 700 or a node (e.g., a processing node 800) implementing one or more of the functions 810 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

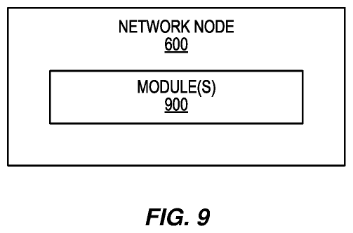

FIG. 9 is a schematic block diagram of the network node 700 according to some other embodiments of the present disclosure. The network node 700 includes one or more modules 900, each of which is implemented in software. The module(s) 900 provide the functionality of the network node 700 described herein. This discussion is equally applicable to the processing node 800 of FIG. 8 where the modules 800 may be implemented at one of the processing nodes 800 or distributed across multiple processing nodes 800.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the FIGURES may show a particular order of operations performed by certain embodiments of the present disclosure, it should be understood that such order is exemplary (e.g., alternative embodiments may perform the operations in a different order, combine certain operations, overlap certain operations, etc.).

### Embodiments

The following are example non-limiting claim embodiments to be used as a basis for future claims. However, the complete content of this application will be used as a basis for future claims.

### Group A: V-SMF

Embodiment 1. A method of providing offload information from a first network to a second network, the method implemented in a first session management function in the first network, the method comprising:
   sending by the first SMF in the first network to a second SMF in the second network a request for a PDU session establishment indicating that the first SMF supports and/or requests authorization for home routed session breakout of the PDU session;
   receiving from the second SMF a message indicating a response including one or more offload IDs each identifying first network-specific offload policies for home routed session breakout to be applied by the first SMF.
Embodiment 2. The method of embodiment 1 wherein the message indicating the response further comprises the first network-specific offload policies identified by each of the one or more offload IDs.
Embodiment 3. The method of embodiment 1, wherein the request for the PDU session establishment includes one or more previously provisioned offload IDs identifying the one or more previously provisioned first network-specific offload policies where each of the one or more previously provisioned offload IDs is optionally tagged with a timestamp indicating when the identified previously provisioned first network-specific offload policy was provisioned.
Embodiment 4. The method of any of embodiments 1-3, wherein the message indicating the response comprises at least one of:
   the one or more previously provisioned offload IDs and the corresponding updated offload policies;
   the one or more first network-specific policies and the related offload identifiers corresponding to the offload identifiers obtained from subscription data, and/or one or more offload identifiers generated from the offload identifiers obtained from the subscription data.
Embodiment 5. The method of any one of embodiments 1 to 4, wherein the method further comprises storing the first network-specific policies (existing, received (new) and updated).
Embodiment 6. The method of embodiment 1 wherein the first network-specific offload policies include one or more Fully Qualified Domain Names (FQDNs) and optionally a range of Internet Protocol (IP) addresses for the allowed Edge Computing services.
Embodiment 7. The method of embodiment 1 wherein the first network-specific offload policies include one or more Fully Qualified Domain Names (FQDNs) and optionally a range of Internet Protocol (IP) addresses for the non-allowed Edge Computing services.
Embodiment 8. The method of embodiments 6 or 7 where in the method further comprises configuring the UL CL/BPs with the received (or updated) first network-specific offload policies.
Embodiment 9. The method of any of embodiments 1 to 2, wherein the first network is a VPLMN and the second network is a HPLMN and the first SMF is a visited SMF and the second SMF is a H-SMF.

### Group B: H-SME

Embodiment 10. A method of providing offload information from a second network to a first network, the method implemented in a second session management function in the second network, the method comprising:
   receiving from a first SMF in the first network a request for a PDU session establishment indicating that the first SMF supports and/or requests authorization for home routed session breakout (HR-SBO) of the PDU session;
   obtaining session management subscription data comprising first network specific traffic offload information comprising:
      an indication of whether the first network is authorized for HR-SBO, and at least one of:
      one or more Offload Identifiers for the list of FQDNs and/or destination IP ranges of one or more Edge Computing (EC) services allowed for HR-SBO, and
      one or more Offload Identifiers for the list of FQDNs and/or destination IP ranges of one or more Edge Computing (EC) services Not-allowed for HR-SBO,
   sending to the first SMF a message indicating a response including one or more offload identifiers each identifying first network-specific offload policies for home routed session breakout to be applied by the first SMF.
Embodiment 11. The method of embodiment 10 further comprising further generating one or more offload identifiers based on the one or more offload identifiers obtained in the session management subscription data and a first network identifier and including the generated one or more identifiers in the message indicating the response to the first SMF.
Embodiment 12. The method of embodiments 10 or 11 wherein the method further comprises retrieving the first network-specific offload policies for each of the one or more offload identifiers included in the subscription data management and/or for each of the generated one or more offload identifiers.
Embodiment 13. The method of any one of embodiments 11-12 wherein the step of retrieving the first network-specific offload policies comprises obtaining the first network-specific offload policies from an internal configuration of the second SMF or a storage or a policy server.
Embodiment 14. The method of any one of embodiments 11-12 wherein the message indicating the response further comprises the retrieved first network-specific offload policies for each of the one or more offload identifiers included in the subscription data management and/or for each of the generated one or more offload identifiers.
Embodiment 15. The method of embodiment 10, wherein the request for the PDU session establishment includes one or more previously provisioned offload Identifiers identifying previously provisioned one or more first network-specific offload policies at the first SMF, where each of the one or more previously provisioned offload Identifiers is optionally tagged with a timestamp indicating when the identified first network-specific offload policy was provisioned.
Embodiment 16. The method of any one of embodiments 11, 12 and 15 wherein the method further comprises determining whether the one or more previously provisioned offload identifiers received from the first SMF are the same or different from the one or more offload identifiers from the session management subscription data and/or from the generated one or more offload identifiers,
   if same, retrieving the one or more first network-specific offload policies for the matched one or more offload identifiers and
   if unmatched, retrieving the one or more first network-specific offload policies for the one or more offload identifiers from the subscription data and/or for the generated one or more offload identifiers, and
   including in the message indicating the response the retrieved one or more first network-specific offload policies and the associated one or more offload identifiers corresponding to the matched one or more offload identifiers and the one or more unmatched offload identifiers obtained from the subscription data and/or from the generation.
Embodiment 17. The method of any one of embodiments 11, 12 and 15 wherein the method further comprises determining whether the one or more previously provisioned offload identifiers received from the first SMF are the same (match) or different from the one or more offload identifiers from the session management subscription data and/or from the generated one or more offload identifiers,
   if same/matching, determining if the timestamp provided with the one or more previously provisioned offload identifiers indicate that the corresponding previously provisioned first network-specific offload policies have expired or need to be updated,
   in response to determining that the one or more previously provisioned first network-specific offload policies have expired or need to be updated, retrieving the one or more updated first network-specific offload policies for the matched one or more offload identifiers,
   in response to determining that the one or more previously provisioned first network-specific offload policies have not expired or do not need to be updated, refraining from retrieving the one or more first network-specific offload policies for the matched one or more offload identifiers,
   including in the message indicating the response the retrieved one or more updated first network-specific offload policies for each of the associated one or more offload identifiers that match with the one or more previously provisioned offload identifiers included in the request.
Embodiment 18. The method of embodiment 17 wherein the message indicating the response further comprises any retrieved one or more first network-specific policies for the one or more unmatched offload identifiers obtained from the subscription data and/or generated.
Embodiment 19. The method of any one of embodiments 11, 12 and 15 wherein the method further comprises determining whether the one or more previously provisioned offload identifiers received from the first SMF are the same (match) or different from the one or more offload identifiers from the session management subscription data and/or from the generated one or more offload identifiers,
   if different/unmatching, retrieving the one or more first network-specific offload policies for the one or more offload identifiers obtained in the session management subscription data and
   including in the message indicating the response the retrieved one or more first network-specific offload policies for each of the associated one or more offload identifiers from the subscription data and/or from the generation.
Embodiment 20. The method of any one of embodiments 14 to 19 wherein the first network-specific offload policies include one or more Fully Qualified Domain Names (FQDNs) and optionally a range of Internet Protocol (IP) addresses for the allowed Edge Computing services.
Embodiment 21. The method of any one of embodiments 14 to 19 wherein the first network-specific offload policies include one or more Fully Qualified Domain Names (FQDNs) and optionally a range of Internet Protocol (IP) addresses for the non-allowed Edge Computing services.
Embodiment 22. A network node adapted to perform the method of any of embodiments 1 to 21.
Embodiment 23. A non-transitory computer-readable storage medium that includes executable instructions that when executed by a processor cause the processor to perform the method of any of embodiments 1 to 21.

The following describes additional 3GPP material including additional embodiments that are based on the embodiments described in this disclosure. The subject matter of this material is not limiting and can be used to derive future claims:

### 3GPP TSG-SA WG2 Meeting #154AH S2-2xxxxx

Electronic meeting, date (revision of S2-2xxxxx)
Source: Ericsson
Title: Discussion of the Editor's Notes for HR-SBO scenario
Document for: Agreement
Agenda Item: 8.2
Work Item/Release: FS_enh_EC/Rel-18
   Abstract of the contribution: This contribution discusses the Editor's Notes related to HR-SBO scenario and proposes way forward

### 1 Introduction

The CR S2211366 for TS 23.548 related to roaming HR-SBO scenario (Key Issue #1) has been accepted during SA2 #154 with the following Editor's Notes:
Editor's Note: The user plane topology in VPLMN supporting HR-SBO is FFS.
Editor's Note: It is FFS whether the AMF sends an indication that the requested session is allowed for HR-SBO PDU Session to the V-SMF. If agreed, this indication can be used for the V-SMF to decide whether to request HR-SBO PDU Session to the H-SMF.
Editor's Note: It is FFS when the V-SMF selects V-EASDF. In other words, V-SMF selects the V-EASDF either 1) before sending Nsmf_PDUSession_Create Request for HR-SBO PDU Session to H-SMF or 2) after receiving Nsmf_PDUSession_Create response from H-SMF.
Editor's Note: It is FFS that the SM subscription data includes 1) HR-SBO authorization indication or 2) HR-SBO authorization information including VPLMN specific offloading policy. If only HR-SBO authorization indication is added, the H-SMF retrieves the VPLMN specific offloading policy from H-PCF if available at H-PCF based on the SLA between HPLMN and VPLMN.
Editor's Note: The detailed information (e.g. FQDN range, IP range, AMBR for the local part of DN or charging policy) of VPLMN specific offloading policy is FFS.
Editor's Note: It is FFS how EAS (re)-discovery procedure for HR-SBO roaming scenario is performed.
   In the following these issues are discussed and a way forward is proposed for them.

### 2 Discussion

### 2.1 Indication for Allowed HR-SBO Session to V-SMF

Upon selecting the V-SMF, the AMF contacts it to set up a PDU session towards the H-SMF. To handle HR-SBO, it requires a specific V-SMF functionality (selecting V-EASDF, requesting HR-SBO PDU Session to the H-SMF etc.) that is not a typical V-SMF. In order that V-SMF be aware that this functionality is required, the AMF should send an indication that the requested session is allowed for HR-SBO PDU Session to the V-SMF.
Proposal 1: the AMF should send an indication that the requested session is allowed for HR-SBO PDU Session to the V-SMF.

### 2.2 Selection of V-EASDF

Since H-SMF may need the V-EASDF IP (to send it to the UE in the PCO message) this means that V-SMF should have selected and send the V-EASDF IP address in the Nsmf_PDUSession_Create Request for HR-SBO PDU Session to H-SMF. Otherwise, another signalling message would be needed to convey the V-EASDF information. If, for some reason, the H-SMF does not finally authorize HR-SBO, there is still no unnecessary signalling or resource wasting in VPLMN.
Proposal 2: the V-SMF should select the V-EASDF, before sending Nsmf_PDUSession_Create Request for HR-SBO PDU Session

### 2.3 Composition of the VPLMN-Specific Offload Policy

The VPLMN-specific offload policy may have different composition, depending on which MNO the Service Provider (SP) is in contract with.
If there is an agreement between the SP and the VPLMN, then EC Application information (e.g., EDIs) is available in VPLMN. In this case, the HPLMN may, as a minimum, provide only the HR-SBO authorization indication to the VPLMN. However, it could be that HPLMN provides other services for the given UE and PDU Session, for other, non-EC applications. If that is the case, then these applications should not be allowed for SBO in VPLMN.
Proposal 3: the VPLMN-specific offload policy should be possible to include traffic descriptors (e.g., destination IP ranges, ports, FQDNs) that are not allowed for HR-SBO.
If there is an agreement between the SP and the HPLMN, then HPLMN needs to provide the offload policy necessary for HR-SBO to VPLMN. The following alternatives are seen regarding the conveyed information to support session breakout:
All information needed (including EDI as defined in TS 23.548) is conveyed. This is to support full-fledged EAS re-discovery procedures as in TS 23.548. This means conveying a large volume of information, like EDI, which is not necessarily PDU session related information, for each PDU Session. Providing the EDI related to VPLMN topology to HPLMN assumes that the SP has service agreements both with VPLMN and HPLMN. This is because VPLMN DNAIs in EDI should be agreed and exchanged between the Service providers (SPs) and the VPLMN first, and only then the SPs can provide EDI related to VPLMN DNAIs to HPLMN. The same chain of communication is required also when VPLMN DNAIs are changed.
The offload policy information includes the EC FQDNs to be configured in V-EASDF and IP ranges to be configured in UL CL/BPs. In this case V-SMF selects the UL CL or BP and L-PSA based on UE location without considering the EAS deployment information. This is proposed in solutions #02, #03, #05 and #25 from TR 23-700-48.
In this case, the information may be structured in the following way:
Offload_ID_A: FQDN_1, . . . ,FQDN_K: IP range_1, . . . , IP range_n . . . .
Offload_ID_B: FQDN_K+1, . . . ,FQDN_M: IP range_n+1, . . . ,IP range_p

### Table 1: FQDNs and IP Address Ranges for the Allowed EC Services

Here, the different rows in the table tagged with Offload_ID_A, B, etc. would correspond to the traffic offload policies for a specific EC service, so the FQDNs can be used to provision V-EASDF in the case of dynamic PSA insertion by DNS-based EAS discovery, while the list of IP ranges are the list of EAS IP ranges that should be configured for a given service in the UL CL/BP. Note that this service-related offload information A, B, etc, is independent of the VPLMN, although some EAS IP ranges will never be configured for a certain VPLMN as they represent service provider deployments in different countries and PLMNs (assuming that UL CL configuration update for a given IP address range happens when the DNS response contains both the ECS and an EAS IP address belonging to the given IP address range).
Another example is to split each row in Table 2 into the country specific IP address ranges, and then the keys A1, A2, B1, B2, etc. would identify both the service and the geographical regions (e.g., MCC) relevant for the IP ranges. This is shown in Table 2 below. Note that the offload IDs A1, A2, B1, B2, etc, may be derived based on the offload ID for the service and VPLMN ID, respectively.

TABLE 2
FQDNs for the allowed EC services indexed according to
the EC service coupled with IP address ranges using MCC

| | | | |
|---|---|---|---|
| Offload_ID_A: | FQDN_1, . . . , FQDN_K | | . . . |
| Offload_ID_A1 | | IP range_1, . . . , | |
| | | IP range_x | |
| Offload_ID_A2 | | IP range_x + | |
| | | 1, . . . , IP | |
| | | range_y | |
| Offload_ID_B: | FQDN_K + 1, . . . , | | . . . |
| | FQDN_M: | | |
| Offload_ID_B1 | | IP range_y + | |
| | | 1, . . . , IP | |
| | | range_z | |
| Offload_ID_B2 | | IP range_z + | |
| | | 1, . . . , IP | |
| | | range_t | |

This information structure thus does not require VPLMN DNAIs, so this approach simplifies the information exchanged between all parties (VPLMN DNAIs in EDI to HPLMN require that Home MNO understands the VPLMN DNAIs, that HPLMN shares them then with the Service providers (SPs) it has agreements with, and that SPs provide EDI related to VPLMN DNAIs and modify it if VPLMN DNAIs change). It also reduces the information H-SMF needs to provide to V-SMF.
   Proposal 4: the VPLMN-specific offload policy should be possible to include traffic descriptors (FQDNs and IP address ranges) that are allowed HR-SBO.
Note: The traffic offload policy for the allowed and not allowed traffic should be mutually exclusive, i.e., either a list of allowed or a list of not allowed traffic descriptors should be sent, but not both
   Proposal 5: in the case when the VPLMN-specific offload policy includes allowed EC application information as in Proposal 4 above, the V-SMF selects the UL CL and L-PSA based on UE location without considering the EAS deployment information

### 2.4 HR-SBO Related Information in the SM Subscription Data in HPLMN

As described in Clause 2.3 above, the VPLMN-specific offload policy can include application information for allowed or not allowed for HR-SBO, including also FQDNs and related IP address ranges, as shown in Table 1 above. Such information is not a typical PCC information thus it cannot be received from H-PCF. Instead, this information should be pre-configured in the H-SMF and updated if the related SLA changes. Besides, SM subscription data in the UDM could be used to inform the H-SMF of which of the traffic offload information should be conveyed to a specific V-SMF.
The following table contains an example of how the Session Management Subscription data to existing UE Subscription data (i.e., Table 5.2.3.3.1-1 in TS 23.502) could be extended with this information:

TABLE 3
Proposed additional Session Management Subscription data
to existing UE Subscription data (to Table 5.2.3.3.1-1)

| Subscription data | | |
|---|---|---|
| type | Field | Description |
| Session Management | For each serving PLMN and DNN in S-NSSAI level subscription data: | |
| Subscription data | Authorization for HR-SBO | Indicates whether this serving PLMN is authorized |
| (additional data for | | to use HR-SBO for the HR-PDU Session |
| HR-SBO) | Allowed services for HR-SBO | Consists of one or more Offload Identifiers for the |
| | | list of FQDNs and/or destination IP ranges of one |
| | | or more EC services allowed for HR-SBO |
| | Not allowed services for HR- | Consists of one or more Offload Identifiers for the |
| | SBO | list of FQDNs and/or destination IP ranges of one |
| | | or more EC service not allowed for HR-SBO |

Each Offload Identifier identifies a service consisting of a list of FQDNs and a list of IP address ranges as defined in Table 1 above. This list may be pre-configured in the H-SMF and updated on demand.
Another advantage is that the H-SMF may also apply the Offload Identifiers as labels to the list of HR-SBO related information to be sent to V-PLMN. If the given V-SMF has already received the traffic offload policies for certain Offload Identifiers, this could be indicated to the H-SMF in any subsequent request to another HR-PDU Session from the same V-SMF, so it is enough that the Offload Identifiers are sent by the H-SMF rather than the whole information be resent again. In this way, the amount of information exchanged between the HPLMN and VPLMN may be reduced. This is illustrated in FIG. 6: Detailed procedure for HR-PDU Session establishment using UDM and offload identifiers as described below:
1. UE sends PDU Session establishment request to V-SMF selected by the AMF.
2. V-SMF selects UPF in VPLMN (that could be based on the policies fetched from V-PCR) and sends Nsmf_PDUSession_Create Request to H-SMF, in which it send the support for and authorization request for HR-SBO, and also provides the V-EASDF address to H-SMF. V-SMF also sends the offload IDs for the offload information previously received from H-SMF (if any) tagged with a timestamp on when they were received.
3. SMF requests the Session Management Subscription data using Nudm_SDM_Get (SUPI, Session Management Subscription data, selected DNN, S-NSSAI of the HPLMN, Serving PLMN ID, [NID]) and subscribes to be notified when this subscription data is modified using Nudm_SDM_Subscribe.
4. UDM responds with the Session Management Subscription data. The data includes the VPLMN-specific traffic offload information e.g., as shown in Table 4.
5. H-SMF checks the offload IDs received in the VPLMN-related offload information, and it may generate further offload IDs from the offload ID received from the UDM and the VPLMN ID. These offload IDs may be used to identify the EAS IP address ranges for an EC service in a geographical region, e.g., MCC of VPLMN, as shown in Table 2. Then, H-SMF compares the offload IDs with the offload IDs received from the V-SMF. It also checks based on the timestamp received whether configuration information has been changed for some of the offload IDs received from the UDM related information.
6. H-SMF sends Nsmf_PDUSession_Create Response to H-SMF. In this it sends the VPLMN-specific offload policies (including also the related offload IDs) corresponding to the offload IDs received from the UDM, expect those for which there were offload IDs received from the V-SMF, except if there has been an update in the meantime.
7. V-SMF sends PDU Session establishment response to the UE
   Proposal 6: the IP ranges and FQDNs in the service-specific offload policy (if available) can be configured in the H-SMF, and which VPLMN-specific policy to be used could be included in the SM subscription data as Offload Identifiers in the UDM.

### 3 Proposal

It is proposed that the above proposals should be considered in the normative work for the HR-SBO case.

### Abbreviations:

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Management Function |
| AN | Access Network |
| ASIC | Application Specific Integrated Circuit |
| AUSF | Authentication Server Function |
| CPU | Central Processing Unit |
| DCI | Downlink Control Information |
| DN | Data Network |
| DSP | Digital Signal Processor |
| EAS | Edge Application Server |
| EC | Edge Computing |
| EDI | EAS Deployment information |
| EDNS | Extension for DNS |
| EHE | Edge Hosting Environment |
| eNB | Enhanced or Evolved Node B |
| EPC | Evolved Packet Core |
| E-UTRA | Evolved Universal Terrestrial Radio Access |
| FPGA | Field Programmable Gate Array |
| FQDN | Fully Qualified Domain Name |
| gNB | New Radio Base Station |
| HPLMN | Home Public Land Mobile Network |
| HR-SBO | Home Routing Session BreakOut |
| IP | Internet Protocol |
| LBO | Local BreakOut |
| LTE | Long Term Evolution |
| MTC | Machine Type Communication |
| NEF | Network Exposure Function |
| NF | Network Function |
| NPN | Non-Public Network |
| NR | New Radio |
| NRF | Network Function Repository Function |
| NSSF | Network Slice Selection Function |
| OTT | Over-the-Top |
| PC | Personal Computer |
| PCF | Policy Control Function |
| PDU | Packet Data Session Unit |
| RAM | Random Access Memory |
| RAN | Radio Access Network |
| ROM | Read Only Memory |
| RP | Reception Point |
| RRH | Remote Radio Head |
| RTT | Round Trip Time |
| SM | Session Management |
| SMF | Session Management Function |
| UDM | Unified Data Management |
| UE | User Equipment |
| UPF | User Plane Function |
| VPLMN | Visited Public Land Mobile Network |

1. A method of transferring policy information between a first network and a home network of a User Equipment (UE) accessing Edge Hosting Environment (EHE) in the first network, the method implemented in a first session management function (SMF) in the first network, the method comprising:
sending by the first SMF in the first network to a second SMF in the home network a request for a Packet Data Unit (PDU) session establishment for the UE indicating that the first SMF requests establishment of the PDU session supporting home routed session breakout (HR-SBO); and
receiving from the second SMF a message indicating a response including one or more offload identifiers (IDs), each ID of the one or more offload IDs identifying one or more first network-specific offload policies for Edge Computing (EC) services, to be applied at the first network.

2. The method of claim 1 wherein the message indicating the response further comprises at least one of the one or more first network-specific offload policies identified by at least one of the one or more offload IDs.

3. The method of claim 1 wherein the request for the PDU session establishment includes one or more previously provisioned offload IDs identifying one or more previously provisioned first network-specific offload policies at the first network from the home network.

4. The method of claim 3 wherein each of the one or more previously provisioned offload IDs is tagged with a timestamp indicating when the one or more previously provisioned first network-specific offload policies was provisioned.

5. The method of claim 1, wherein the message indicating the response further comprises the one or more previously provisioned offload IDs with corresponding updated first network-specific offload policies.

6. The method of claim 5 wherein the method further comprises replacing the one or more previously provisioned first network-specific offload policies with the updated first network-specific offload policies corresponding to the one or more previously provisioned offload IDs.

7. The method of claim 1 wherein the one or more offload IDs in the message correspond to at least one of:
one or more subscription offload IDs obtained from subscription data for the UE, and
one or more generated offload IDs based on the one or more subscription offload IDs and the one or more previously provisioned offload IDs included in the request for the PDU session establishment.

8. The method of claim 2, wherein the method further comprises storing the received one or more first network-specific offload policies identified by the one or more offload IDs.

9. The method of claim 1 wherein the first network-specific offload policies include at least one of:
one or more Fully Qualified Domain Names (FQDNs) and
a range of Internet Protocol (IP) addresses for allowed Edge Computing services.

10. The method of claim 1 wherein the first network-specific offload policies include at least one of:
one or more Fully Qualified Domain Names (FQDNs) and
a range of Internet Protocol (IP) addresses for non-allowed Edge Computing services.

11. The method of claim 1 wherein the method further comprises configuring a User Plane Function with an uplink classifier branch point (UL CL/BP) with the first network-specific offload policies and/or updated offload policies.

12. The method of claim 1, wherein the first network is a Visited Public Land Mobile Network (VPLMN), the first SMF is a Visited SMF (V-SMF) and the second SMF is a Home SMF (H-SMF).

13. (canceled)

14. (canceled)

15. (canceled)

16. (canceled)

17. (canceled)

18. (canceled)

19. (canceled)

20. (canceled)

21. (canceled)

22. (canceled)

23. A network node comprising one or more processors and memory comprising instructions which when executed by the one or more processors configures the network node to;
send by a first (Session Management Function) SMF in a first network to a second SMF in a home network of a User Equipment (UE) a request for a Packet Data Unit (PDU) session establishment for the UE indicating that the first SMF requests establishment of a PDU session supporting home routed session breakout (HR-SBO); and
receiving from the second SMF a message indicating a response including one or more offload identifiers (IDs), each ID of the one or more offload IDs identifying one or more first network-specific offload policies for Edge Computing (EC) services, to be applied at the first network.

24. (canceled)

25. The network node of claim 23, wherein the message indicating the response further comprises the one or more previously provisioned offload IDs with corresponding updated first network-specific offload policies.

26. The network node of claim 23 wherein the one or more processors of the network node further configures the network node to replace the one or more previously provisioned first network-specific offload policies with the updated first network-specific offload policies corresponding to the one or more previously provisioned offload IDs.

27. The network node of claim 23 wherein the one or more offload IDs in the message correspond to at least one of:
one or more subscription offload IDs obtained from subscription data for the UE, and
one or more generated offload IDs based on the one or more subscription offload IDs and the one or more previously provisioned offload IDs included in the request for the PDU session establishment.
